(19) United States
(12) Patent Application Publication
(10) Pub. No.: US 2021/0118582 A1
(43) Pub. Date: Apr. 22, 2021

(54) METHOD FOR CONTROLLING IOT DEVICE AND ELECTRONIC DEVICE THEREFOR

(71) Applicant: Samsung Electronics Co., Ltd., Suwon-si (KR)

(72) Inventors: Yoonju LEE, Suwon-si (KR); Jaeyong SHIN, Suwon-si (KR); Chaigil LIM, Suwon-si (KR)

(21) Appl. No.: 17/073,099

(22) Filed: Oct. 16, 2020

(30) Foreign Application Priority Data
Oct. 16, 2019 (KR) 10-2019-0128460
Feb. 6, 2020 (KR) 10-2020-0014560

(51) Int. Cl. G16Y 40/30; G10L 15/26; G16Y 20/10; G16Y 20/20

(52) U.S. Cl. CPC G16Y 40/30; G16Y 20/20; G16Y 20/10; G10L 15/26

(57) ABSTRACT

A server that supports an operation of an IoT environment a communication circuit and a processor. The processor is electrically connected with the communication circuit. The processor is configured to receive a sound signal corresponding to an utterance input of a user from a first electronic device through the communication circuit. The processor is configured to derive identification information and a control command of an IoT device from the sound signal. The processor is configured to determine whether it is possible to control the IoT device by using the first electronic device. The processor is configured to transmit a control signal corresponding to the control command to a second electronic device associated with the IoT device based on a result of the determination indicating the second electronic device is to use a specified wavelength to control the IoT device.

### CROSS-REFERENCE TO RELATED APPLICATIONS

This application is based on and claims priority under 35 U.S.C. § 119 to Korean Patent Application No. 10-2020-0014560 filed on Feb. 6, 2020, and Korean Patent Application No. 10-2019-0128460 filed on Oct. 16, 2019 in the Korean Intellectual Property Office, the disclosures of which are herein incorporated by reference in their entirety.

### BACKGROUND

### 1. Field

The disclosure relates to a technology for controlling an Internet of Things (IoT) device.

### 2. Description of Related Art

With the commercialization of an intelligent communication infrastructure between things in which a communication function is embedded, that is, an Internet of Things (IoT) environment, there is an attempt to construct various operation platforms for an IOT environment. For example, in a conventional IoT environment, an IoT device (e.g., a television (TV)) may operate under control of an electronic device (e.g., an artificial intelligence (AI) speaker) by registering the IoT device at an IoT server.

The above information is presented as background information only to assist with an understanding of the disclosure. No determination has been made, and no assertion is made, as to whether any of the above might be applicable as prior art with regard to the disclosure.

### SUMMARY

To control an IoT device (e.g., a TV) in a conventional IoT environment, an electronic device (e.g., an AI speaker) may transmit a control signal to the IoT device. For example, an electronic device located at one place (e.g., a bedroom) may transmit a control signal to an IoT device located at another place (e.g., a living room).

However, in the case of an electronic device that does not support the emission of a specified wavelength (e.g., an infrared light), it may be difficult to control an IoT device that is controlled by using the specified wavelength. For example, in the case where IoT devices controlled by using the specified wavelength are located at places (e.g., a bedroom and a living room) separated from each other, the electronic device that does not support the emission of the specified wavelength may fail to transmit the control signal.

Aspects of the disclosure are to address at least the above-mentioned problems and/or disadvantages and to provide at least the advantages described below. Accordingly, an aspect of the disclosure is to provide a method for controlling an IoT device controlled by using a specified wavelength (e.g., an infrared light), and a server and an electronic device for supporting the same.

In accordance with an aspect of the disclosure, a server may include a communication circuit, and a processor that is electrically connected with the communication circuit. The processor may receive a sound signal corresponding to an utterance input of a user from a first electronic device through the communication circuit, may derive identification information and a control command of an IoT device from the sound signal, may determine whether it is possible to control the IoT device by using the first electronic device, and may transmit a control signal corresponding to the control command to a second electronic device associated with the IoT device based on a result of the determination such that the second electronic device controls the IoT device by using a specified wavelength.

In accordance with another aspect of the disclosure, an electronic device may a communication circuit, and a processor that is electrically connected with the communication circuit. The processor may transmit a sound signal corresponding to an utterance input of a user to a server through the communication circuit, and when identification information and a control command of an IoT device are derived from the sound signal by the server, the processor may allow the server to transmit a control signal corresponding to the control command to another electronic device associated with the IoT device, depending on it is possible to control the IoT device corresponding to the derived identification information by using the electronic device.

In accordance with another aspect of the disclosure, a method for controlling an IoT device may include receiving a sound signal corresponding to an utterance input of a user from a first electronic device, deriving identification information and a control command of the IoT device from the sound signal, determining whether it is possible to control the IoT device by using the first electronic device, and transmitting a control signal corresponding to the control command to a second electronic device associated with the IoT device based on a result of the determination such that the second electronic device controls the IoT device by using a specified wavelength.

Other aspects, advantages, and salient features of the disclosure will become apparent to those skilled in the art from the following detailed description, which, taken in conjunction with the annexed drawings, discloses various embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an IoT environment according to an embodiment;

FIG. 2 illustrates components in an IoT environment according to an embodiment;

FIG. 3 illustrates components in an IoT environment according to an embodiment;

FIG. 4 illustrates a process of controlling an IoT device, according to an embodiment;

FIG. 5 illustrates a process of controlling an IoT device, according to an embodiment;

FIG. 6 illustrates a process of controlling an IoT device, according to an embodiment;

FIG. 7 illustrates a process of controlling an IoT device, according to various embodiments;

FIG. 8 illustrates an IoT device control environment according to an embodiment;

FIG. 9 illustrates an IoT device control environment according to an embodiment;

FIG. 10 is a block diagram illustrating an electronic device 901 in a network environment 900 according to various embodiments;

FIG. 11 illustrates a device registration and control system according to various embodiments;

FIG. 12 illustrates a flowchart of a device registration method using an external electronic device managing app of an electronic device according to various embodiments;

FIG. 13 illustrates a user interface screen that is output when an external user is using a registration step user interface of an external electronic device managing app, according to various embodiments;

FIG. 14 illustrates a user interface screen that is output when an external user is using a registration step user interface of an external electronic device managing app, according to various embodiments;

FIGS. 15A and 15B illustrate an overall flowchart of a registration system according to various embodiments;

FIG. 16 illustrates an additional user interface when an external electronic device to be registered at an electronic device is a TV or a set-top box, according to various embodiments;

FIG. 17 illustrates an operation flowchart of an additional user interface when an external electronic device to be registered at an electronic device is a TV, according to various embodiments;

FIG. 18 illustrates a user interface providing a remote control function to control an external electronic device, according to various embodiments; and

In the description of the drawings, the same or similar reference numerals may be used for the same or similar components.

### DETAILED DESCRIPTION

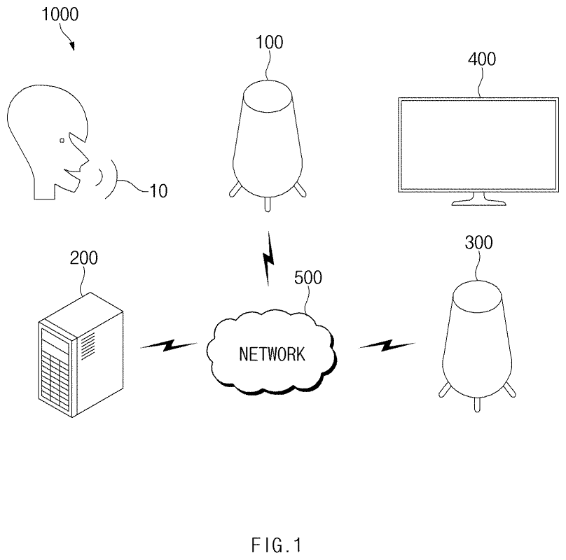

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments will be described with reference to accompanying drawings. However, this is not intended to limit the technologies described in the disclosure to specific embodiments, and it should be understood to include various modifications, equivalents, and/or alternatives of the embodiments.

FIG. 1 illustrates an IoT environment according to an embodiment.

Referring to FIG. 1, in an IoT environment 1000 according to an embodiment, a sound signal 10 corresponding to an utterance input of a user transferred from a first electronic device 100 (e.g., an AI speaker) to an IoT server 200 may allow a second electronic device 300 (e.g., another AI speaker) to control an IoT device 400 (e.g., a TV). In this case, the first electronic device 100 (or the second electronic device 300) may transmit/receive at least one of the sound signal 10 corresponding to the utterance input of the user, a control signal for the IoT device 400, and device identification information of the IoT device 400 through the IoT server 200 and a network 500.

According to an embodiment, the IoT environment 1000 may include the first electronic device 100, the IoT server 200, the second electronic device 300, the IoT device 400, and the network 500.

According to an embodiment, the first electronic device 100 may obtain an input corresponding to an utterance of the user as the sound signal 10. For example, the first electronic device 100 may obtain the sound signal 10 associated with a control command of the IoT device 400. In various embodiments, the first electronic device 100 may transmit the obtained sound signal 10 to the IoT server 200. In various embodiments, the first electronic device 100 may fail to emit a specified wavelength (e.g., an infrared wavelength).

According to an embodiment, the IoT server 200 may cause the second electronic device 300 to control the IoT device 400 based on a result of analyzing the sound signal 10 received from the first electronic device 100. For example, the IoT server 200 may derive identification information and the control command of the IoT device 400 from the sound signal 10. Also, the IoT server 200 may determine whether it is possible to control the IoT device 400 corresponding to the derived identification information by using the first electronic device 100. When it is impossible to control the IoT device 400 by using the first electronic device 100, the IoT server 200 may transmit a control signal corresponding to the control command to the second electronic device 300 associated with the IoT device 400. In various embodiments, the IoT server 200 may store the IoT device 400 information and the second electronic device 300 information in association with a specified place.

According to an embodiment, the second electronic device 300 may control the IoT device 400 depending on the control signal received from the IoT server 200. For example, when the second electronic device 300 receives the control signal from the IoT server 200, the second electronic device 300 may transmit the control signal by using a specified wavelength (e.g., an infrared wavelength). In this case, because the second electronic device 300 is linked to the IoT device 400 with regard to the specified place, the second electronic device 300 may emit the specific wavelength to the IoT device 400.

According to an embodiment, the IoT device 400 may perform an operation (e.g., power OFF) associated with the control signal under control of the second electronic device 300. In this case, the IoT device 400 may receive the control signal only through the specified wavelength (e.g., an infrared wavelength).

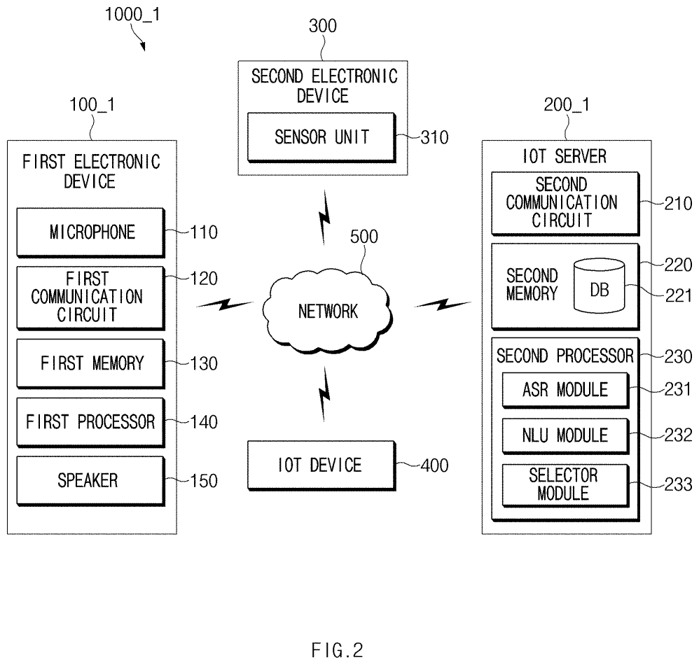

FIG. 2 illustrates components in an IoT environment according to an embodiment.

Referring to FIG. 2, each of a first electronic device 100_1, an IoT server 200_1, and the second electronic device 300 in an IoT environment 1000_1 may include components. Below, components included in the IoT environment 1000_1 will be described.

According to an embodiment, the first electronic device 100_1 may communicate with the IoT server 200_1, the second electronic device 300, and/or the IoT device 400 over the network 500 (e.g., an LAN, a WAN, an Internet, an Ad-hoc network, or a telephone network). For example, the first electronic device 100_1 may obtain a sound signal (e.g., the sound signal 10 of FIG. 1) corresponding to an utterance input of the user and may transmit the sound signal to the IoT server 200_1 by connecting to the network 500 through wired or wireless communication. The first electronic device 100_1 may include a microphone 110, a first communication circuit 120, a first memory 130, a first processor 140, and/or a speaker 150.

According to an embodiment, the microphone 110 may receive a sound signal (e.g., an input corresponding to an utterance of a user). For example, the microphone 110 may operate in a state of being always driven (e.g., an always on state) for the purpose of receiving a sound signal. For another example, the microphone 110 may be activated according to a user input on a button disposed at a portion of the first electronic device 100_1 and may then operate.

In various embodiments, at least a portion of the microphone 110 may be exposed to the outside of the first electronic device 100_1 for the purpose of efficiently receiving a sound signal. For another example, the microphone 110 may be positioned within a housing of the first electronic device 100_1.

According to an embodiment, the first communication circuit 120 may support a communication function of the first electronic device 100_1 such that the first electronic device 100_1 communicates with the IoT server 200_1, the second electronic device 300, and/or the IoT device 400. For example, the first communication circuit 120 may transmit/receive at least one of data, a signal, and information about an operation of the IoT environment 1000_1 by connecting to the network 500, which is constructed between the IoT server 200_1, the second electronic device 300, and/or the IoT device 400, through wired and/or wireless communication complying with a defined protocol.

According to an embodiment, the first memory 130 may store query data to be output through the speaker 150. For example, the first memory 130 may store at least one of at least one syllable associated with the query data, a word in which the at least one syllable is included, or a sentence in which the word is included. In this case, the query data may be output through the speaker 150 as a sound associated with a sound signal (e.g., an input corresponding to an utterance of a user). For another example, the first memory 130 may store at least one command associated with a function operation control of components of the first electronic device 100_1. For another example, the first memory 130 may store at least one data associated with an operation of the first electronic device 100_1. For example, the first memory 130 may store at least one of identification information (e.g., model information, version information, operator information, and/or operating system information) of the first electronic device 100_1 and information about a location of the first electronic device 100_1 disposed in the IoT environment 1000_1.

According to an embodiment, the first processor 140 may control components of the first electronic device 100_1. For example, the first processor 140 may be electrically or operatively connected with components of the first electronic device 100_1, and the first processor 140 may transfer at least one command associated with a function operation to the components or may perform various kinds of operations, data processing, or the like.

According to an embodiment, the first processor 140 may obtain a sound signal (e.g., the sound signal 10 of FIG. 1) through the microphone 110. Also, the first processor 140 may transmit the sound signal to the IoT server 200_1 through the first communication circuit 120.

According to an embodiment, the first processor 140 may allow specified sound data to be output through the speaker 150. For example, the first processor 140 may allow a sound-type query, which the user is able to hear, to be output through the speaker 150.

In various embodiments, the first processor 140 may be at least one of a central processing unit, an application processor, and a communication processor.

According to an embodiment, the speaker 150 may output specified sound data. For example, in the case where an operating state of the IoT device 400 is changed according to a control operation of the IoT server 200_1 associated with the sound signal, the speaker 150 may output a sound-type query stored in the first memory 130.

In various embodiments, the speaker 150 may be implemented with at least one speaker. Also, at least a portion of the speaker 150 may be exposed to the outside of the first electronic device 100_1 for the purpose of efficiently outputting the sound data. For another example, the speaker 150 may be positioned within the housing of the first electronic device 100_1.

In various embodiments, the first electronic device 100_1 may be a hub device or an artificial intelligence (AI) device that acts as a repeater between the IoT server 200_1, the second electronic device 300, and the IoT device 400. In this regard, at least one first electronic device 100_1 may be disposed at least a portion of at least one space physically or logically defined within a specific region where the IoT environment 1000_1 is formed.

In various embodiments, the first electronic device 100_1 may not include at least one of the above components or may further include any other component(s). For example, the at least one first electronic device 100_1 may further include a battery supplying a power to the above components or a display outputting various kinds of content.

In various embodiments, the first electronic device 100_1 may be connected with the IoT server 200_1 through an access point (e.g., a Wi-Fi router).

According to an embodiment, the IoT server 200_1 may integrally manage the first electronic device 100_1, the second electronic device 300, and the IoT device 400 that are registered at the IoT environment 1000_1 or the IoT server 200_1. For example, depending on the sound signal (e.g., the sound signal 10 of FIG. 1) received from the first electronic device 100_1, the IoT server 200_1 may allow one associated with the IoT device 400 from among the first electronic device 100_1 or the second electronic device 300 to control the IoT device 400. Also, the IoT server 200_1 may analyze the sound signal received from the first electronic device 100_1 and may process an input corresponding to an utterance of the user. The IoT server 200_1 may include a second communication circuit 210, a second memory 220, and a second processor 230.

According to an embodiment, the second communication circuit 210 may support a communication function of the IoT server 200_1 such that the IoT server 200_1 communicates with the first electronic device 100_1, the second electronic device 300, and the IoT device 400. For example, the second communication circuit 210 may transmit/receive at least one of the data, the signal, and the information about the operation of the IoT environment 1000_1 by connecting to the network 500, which is constructed between the first electronic device 100_1, the second electronic device 300, and the IoT device 400, through wired and/or wireless communication complying with a defined protocol.

According to an embodiment, the second memory 220 may store the IoT device 400 and the second electronic device 300 (or the first electronic device 100_1) in association with a specified place. The second memory 220 may include a database 221 in which various kinds of information of the second memory 220 are organized.

In various embodiments, the IoT device 400 information and the second electronic device 300 information (or the first electronic device 100_1 information) mutually linked with regard to a specified place may be stored in the database 221. For example, a table (or a mapping table) associated with mapping between the IoT device 400 and the second electronic device 300 (or the first electronic device 100_1) may be stored in the database 221. For example, the mapping table may be identical or similar to Table 1 below.

TABLE 1

| | | | Electronic device capable of |
|---|---|---|---|
| ID | Place | IoT device | controlling IoT device |
| 1 | Living | Identification | Identification information of |
| | room | information of TV | second electronic device |

Referring to Table 1 above, a TV information disposed at a specified place being a living room may be stored in the database 221 according to an embodiment in association with a second electronic device. For example, the TV may be mapped on the second electronic device located at a place capable of controlling the TV, and the mapped result may be stored in the database 221. In this case, a second electronic device being any other electronic device associated with the TV may be disposed at the living room being the same place as the TV. That is, the second electronic device 300 information (or the first electronic device 100_1 information) that is capable of transmitting a control signal to the IoT device 400 by using a specified wavelength may be stored in the database 221 in a state of being linked to the IoT device 400 with regard to the specified place.

According to an embodiment, the second processor 230 may control components of the IoT server 200_1. For example, the second processor 230 may be electrically or operatively connected with components of the IoT server 200_1, and the second processor 230 may transfer at least one command associated with a function operation to the components or may perform various kinds of operations, data processing, or the like.

According to an embodiment, the second processor 230 may receive a sound signal (e.g., the sound signal 10 of FIG. 1) transmitted from the first electronic device 100_1 through the second communication circuit 210. Also, the second processor 230 may derive the identification information and the control command of the IoT device 400 from the sound signal. For example, the second processor 230 may transmit a control signal corresponding to the control command to the second electronic device 300 (or the first electronic device 100_1) capable of transferring the control command to the IoT device 400 corresponding to the derived identification information.

According to an embodiment, the second processor 230 may analyze and process a sound signal (e.g., the sound signal 10 of FIG. 1) transmitted from the first electronic device 100_1 through the second communication circuit 210. The sound signal may involve, for example, a command or an intention associated with an operation of the IoT device 400 present at (or present at a place adjacent to) the same place as the second electronic device 300 (or the first electronic device 100_1). With regard to analyzing and processing the sound signal, the second processor 230 may include an automatic speech recognition (ASR) module 231 and a natural language understanding (NLU) module 232. In various embodiments, the ASR module 231 and the NLU module 232 may be independent of each other or may be at least partially integrated.

According to an embodiment, the ASR module 231 may recognize a sound signal (e.g., the sound signal 10 of FIG. 1) received from the first electronic device 100_1 and may convert the sound signal into text data. For example, the ASR module 231 may convert the sound signal into text data by using an acoustic model including at least one information about an utterance or a language model including combination information of phonemes.

According to an embodiment, the NLU module 232 may derive an intention of a user utterance input associated with the sound signal (e.g., the sound signal 10 of FIG. 1) based on the text data transferred from the ASR module 231. For example, the NLU module 232 may derive the intention of the user utterance input associated with the sound signal by dividing the text data in a grammatical unit (e.g., a word, a phrase, or a morpheme), analyzing a grammatical element or a linguistic characteristic for each unit, and determining a meaning of the text data. Also, the NLU module 232 may derive the identification information of the IoT device 400 based on the text data transferred from the ASR module 231.

According to an embodiment, the second processor 230 may select the second electronic device 300 (or the first electronic device 100_1) capable of controlling the IoT device 400. With regard to the selection, the second processor 230 may include a selector module 233.

According to an embodiment, the selector module 233 may be provided with information about the second electronic device 300 (or the first electronic device 100_1), which is capable of controlling the IoT device 400 corresponding to the identification information derived from the NLU module 232, from the second memory 220. For example, in the case where one second electronic device 300 (or one first electronic device 100_1) information is provided from the second memory 220, the selector module 233 may select the second electronic device 300 (or the first electronic device 100_1) thus provided, as a control device for the IoT device 400. For another example, in the case where a plurality of second electronic devices 300 (or a plurality of first electronic device 100_1) are provided from the second memory 220, the selector module 233 may select one second electronic device 300 (or one first electronic device 100_1) based on at least one of network performance information and location information about the IoT device 400. In various embodiments, the location information may be information for selecting the second electronic device 300, which is located within a shorter distance, from among the plurality of second electronic devices 300 associated with the IoT device 400. In various embodiments, the network performance information may be information for selecting the second electronic device 300, which is connectable to the network 500 or has a high communication efficiency for the network 500, from among the plurality of second electronic devices 300 associated with the IoT device 400.

In various embodiments, the second processor 230 may be at least one of a central processing unit, an application processor, and a communication processor.

According to an embodiment, the second electronic device 300 may control the IoT device 400 depending on the control signal received from the IoT server 200_1. For example, the second electronic device 300 may transmit the control signal by using a specified wavelength (e.g., an infrared wavelength) in a direction in which the IoT device 400 is disposed. The second electronic device 300 may include a sensor unit 310 capable of emitting the specified wavelength.

According to an embodiment, the sensor unit 310 may transmit a signal of a specified wavelength (e.g., an infrared wavelength) toward the IoT device 400. In this case, the control signal may be included in the signal of the specified wavelength transmitted from the sensor unit 310. In various embodiments, the sensor unit 310 may be an infrared sensor. Also, at least a portion of the sensor unit 310 may be exposed to the outside such that the emission of the specified wavelength toward the IoT device 400 is possible, and the exposed portion may be disposed to face the IoT device 400. For example, the signal of the specified wavelength may be defined by a frequency, a length, and/or a pattern.

In various embodiments, the second electronic device 300 may include components that are identical or similar to those of the first electronic device 100_1. For example, in the case where the second electronic device 300 including components identical or similar to those of the first electronic device 100_1 obtains a sound signal (e.g., the sound signal 10 of FIG. 1) from the user, the second electronic device 300 may transmit the sound signal to the IoT server 200_1 such that a control for the IoT device 400 is possible.

In various embodiments, the second electronic device 300 may be connected with the IoT server 200_1 through an access point (e.g., a Wi-Fi router).

According to an embodiment, the IoT device 400 may operate under control of the second electronic device 300 (or the first electronic device 100_1). For example, when the control signal of the specified wavelength is transmitted from the second electronic device 300, the IoT device 400 may operate (e.g., may be powered off) according to the control signal. In this case, the IoT device 400 may be linked to the second electronic device 300 with regard to a specified place.

In various embodiments, the IoT device 400 may transmit various kinds of operating information (e.g., state information, function information, and the like) to the first electronic device 100_1, the IoT server 200_1, the second electronic device 300, or a mobile communication terminal of the user in the form of a batch or a stream.

In various embodiments, the IoT device 400 may be an IoT technology-based service target (e.g., an electronic product).

The description is given in FIG. 2 as the IoT device 400 is an IoT technology-based electronic product, but embodiments of the disclosure are not limited thereto. In the specification, the term “IoT device” may mean any electronic device capable of being registered at an IoT server. For example, the IoT device 400 may be a legacy electronic device that does not include an Internet access function. In this case, the legacy electronic device may operate based on the signal of the specified wavelength from the second electronic device 300. In the case where the IoT device 400 is an electronic device capable of supporting an Internet access, the IoT device 400 may operate based on a signal from the IoT server 200_1.

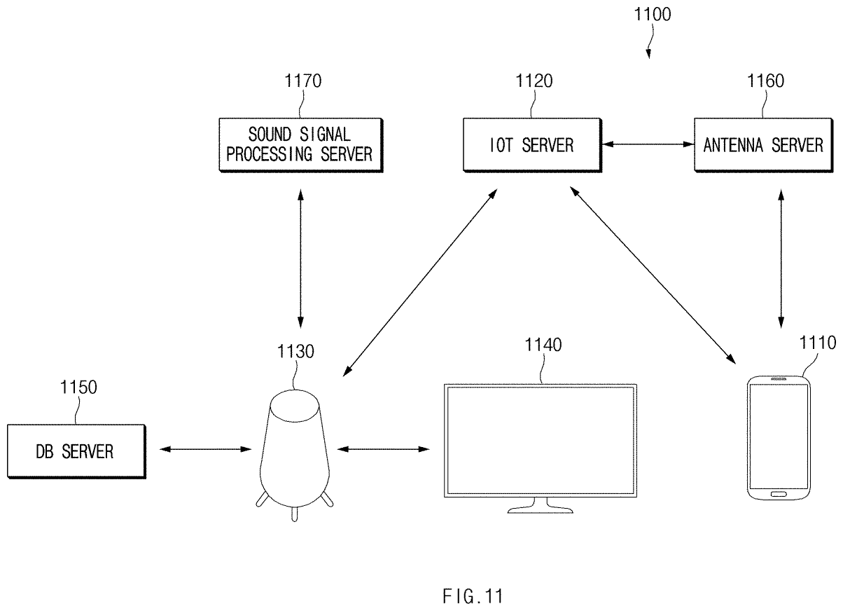

An example is illustrated in FIG. 2 as the IoT server 200_1 is one server, but embodiments of the disclosure are not limited thereto. For example, the IoT server 200_1 may be implemented with a plurality of servers (e.g., a first IoT server 1120 and a sound signal processing server 1170 of FIG. 11). In an embodiment, the database 221 of the IoT server 200_1 and the components 231, 232, and 233 for recognizing a sound command may be implemented with separate servers.

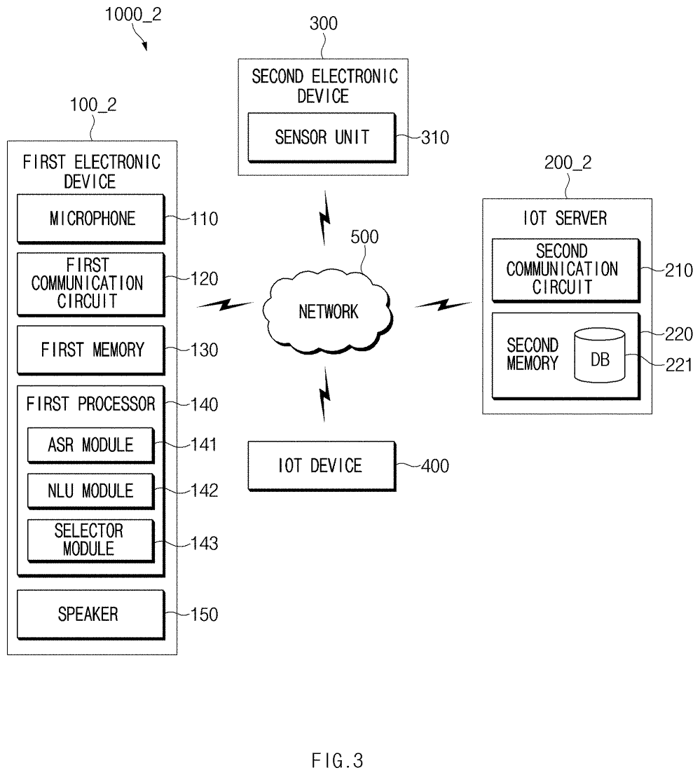

FIG. 3 illustrates components in an IoT environment according to an embodiment.

Referring to FIG. 3, each of a first electronic device 100_2, an IoT server 200_2, and the second electronic device 300 in an IoT environment 1000_2 may include components. Below, components included in the IoT environment 1000_2 will be described.

According to an embodiment, the first electronic device 100_2 may communicate with the IoT server 200_2, the second electronic device 300, and/or the IoT device 400 over the network 500 (e.g., an LAN, a WAN, an Internet, an Ad-hoc network, or a telephone network). For example, the first electronic device 100_2 may obtain a sound signal (e.g., the sound signal 10 of FIG. 1) corresponding to an utterance input of the user and may select the second electronic device 300 associated with the sound signal by connecting to the network 500 through wired or wireless communication. The first electronic device 100_2 may include the microphone 110, the first communication circuit 120, the first memory 130, the first processor 140, and the speaker 150.

According to an embodiment, the microphone 110 may receive a sound signal (e.g., an input corresponding to an utterance of a user). For example, the microphone 110 may operate in a state of being always driven (e.g., an always on state) for the purpose of receiving a sound signal. For another example, the microphone 110 may be activated according to a user input on a button disposed at a portion of the first electronic device 100_2 and may then operate.

In various embodiments, at least a portion of the microphone 110 may be exposed to the outside of the first electronic device 100_2 for the purpose of efficiently receiving a sound signal.

According to an embodiment, the first communication circuit 120 may support a communication function of the first electronic device 100_2 such that the first electronic device 100_2 communicates with the IoT server 200_2, the second electronic device 300, and the IoT device 400. For example, the first communication circuit 120 may transmit/receive at least one of data, a signal, and information about an operation of the IoT environment 1000_2 by connecting to the network 500, which is constructed between the IoT server 200_2, the second electronic device 300, and the IoT device 400, through wired and/or wireless communication complying with a defined protocol.

According to an embodiment, the first memory 130 may store query data to be output through the speaker 150. For example, the first memory 130 may store at least one of at least one syllable associated with the query data, a word in which the at least one syllable is included, or a sentence in which the word is included. In this case, the query data may be output through the speaker 150 as a sound associated with a sound signal (e.g., an input corresponding to an utterance of a user). For another example, the first memory 130 may store at least one command associated with a function operation control of components of the first electronic device 100_2. For another example, the first memory 130 may store at least one data associated with an operation of the first electronic device 100_2. For example, the first memory 130 may store at least one of identification information (e.g., model information, version information, operator information, or operating system information) of the first electronic device 100_2 and information about a location of the first electronic device 100_2 disposed in the IoT environment 1000_2.

According to an embodiment, the first processor 140 may control components of the first electronic device 100_2. For example, the first processor 140 may be electrically or operatively connected with components of the first electronic device 100_2, and the first processor 140 may transfer at least one command associated with a function operation to the components or may perform various kinds of operations, data processing, or the like.

According to an embodiment, the first processor 140 may derive identification information and a control command of the IoT device 400 from a sound signal (e.g., the sound signal 10 of FIG. 1) received through the microphone 110. For example, the first processor 140 may transmit a control signal corresponding to the control command to the second electronic device 300 capable of transferring the control command to the IoT device 400 corresponding to the derived identification information.

According to an embodiment, the first processor 140 may analyze and process a sound signal (e.g., the sound signal 10 of FIG. 1) received through the first communication circuit 120. The sound signal may involve, for example, a command or an intention associated with an operation of the IoT device 400 present at (or present at a place adjacent to) the same place as the second electronic device 300. With regard to analyzing and processing the sound signal, the first processor 140 may include an automatic speech recognition (ASR) module 141 and a natural language understanding (NLU) module 142. In various embodiments, the ASR module 141 and the NLU module 142 may be independent of each other or may be at least partially integrated.

According to an embodiment, the ASR module 141 may recognize a sound signal (e.g., the sound signal 10 of FIG. 1) received from the first communication circuit 120 and may convert the sound signal into text data. For example, the ASR module 141 may convert the sound signal into text data by using an acoustic model including at least one information about an utterance or a language model including combination information of phonemes.

According to an embodiment, the NLU module 142 may derive an intention of a user utterance input associated with the sound signal (e.g., the sound signal 10 of FIG. 1) based on the text data transferred from the ASR module 141. For example, the NLU module 142 may derive the intention of the user utterance input associated with the sound signal by dividing the text data in a grammatical unit (e.g., a word, a phrase, or a morpheme), analyzing a grammatical element or a linguistic characteristic for each unit, and determining a meaning of the text data. Also, the NLU module 142 may derive the identification information of the IoT device 400 based on the text data transferred from the ASR module 141.

According to an embodiment, the first processor 140 may select the second electronic device 300 capable of controlling the IoT device 400. With regard to the selection, the first processor 140 may include a selector module 143.

According to an embodiment, the selector module 143 may be provided with information about the second electronic device 300, which is capable of controlling the IoT device 400 corresponding to the identification information derived from the NLU module 142, from the IoT server 200_2. For example, in the case where one second electronic device 300 information is provided from the IoT server 200_2, the selector module 143 may select the second electronic device 300 thus provided, as a control device for the IoT device 400. For another example, in the case where a plurality of second electronic devices 300 are provided from the IoT server 200_2, the selector module 143 may select one second electronic device 300 based on at least one of network performance information and location information about the IoT device 400. In various embodiments, the location information may be information for selecting the second electronic device 300, which is located within a shorter distance, from among the plurality of second electronic devices 300 associated with the IoT device 400. In various embodiments, the network performance information may be information for selecting the second electronic device 300, which is connectable to the network 500 or has a high communication efficiency for the network 500, from among the plurality of second electronic devices 300 associated with the IoT device 400.

According to an embodiment, the first processor 140 may allow specified sound data to be output through the speaker 150. For example, the first processor 140 may allow a sound-type query, which the user is able to hear, to be output through the speaker 150.

In various embodiments, the first processor 140 may be at least one of a central processing unit, an application processor, and a communication processor.

According to an embodiment, the speaker 150 may output specified sound data. For example, in the case where an operating state of the IoT device 400 is changed according to a control operation of the IoT server 200_2 associated with the sound signal, the speaker 150 may output a sound-type query stored in the first memory 130.

In various embodiments, the speaker 150 may be implemented with at least one speaker. Also, at least a portion of the speaker 150 may be exposed to the outside of the first electronic device 100_2 for the purpose of efficiently outputting the sound data.

In various embodiments, the first electronic device 100_2 may be a hub device or an artificial intelligence (AI) device that acts as a repeater between the IoT server 200_2, the second electronic device 300, and the IoT device 400. In this regard, at least one first electronic device 100_2 may be disposed at least a portion of at least one space physically or logically defined within a specific region where the IoT environment 1000_2 is formed.

In various embodiments, the first electronic device 100_2 may not include at least one of the above components or may further include any other component(s). For example, the at least one first electronic device 100_2 may further include a battery supplying a power to the above components or a display outputting various kinds of content.

In various embodiments, the first electronic device 100_2 may be connected with the IoT server 200_2 through an access point (e.g., a Wi-Fi router).

According to an embodiment, the IoT server 200_2 may integrally manage the first electronic device 100_2, the second electronic device 300, and the IoT device 400 that are registered at the IoT environment 1000_2 or the IoT server 200_2. For example, the IoT server 200_2 may provide information about the second electronic device 300 associated with the IoT device 400 depending on a request of the first electronic device 100_2. The IoT server 200_2 may include the second communication circuit 210 and the second memory 220.

According to an embodiment, the second communication circuit 210 may support a communication function of the IoT server 200_2 such that the IoT server 200_2 communicates with the first electronic device 100_2, the second electronic device 300, and the IoT device 400. For example, the second communication circuit 210 may transmit/receive at least one of the data, the signal, and the information about the operation of the IoT environment 1000_2 by connecting to the network 500, which is constructed between the first electronic device 100_2, the second electronic device 300, and the IoT device 400, through wired and/or wireless communication complying with a defined protocol.

According to an embodiment, the second memory 220 may store the IoT device 400 information and the second electronic device 300 information (or the first electronic device 100_2 information) in association with a specified place. The second memory 220 may include the database 221 in which various kinds of information of the second memory 220 are organized.

In various embodiments, the IoT device 400 information and the second electronic device 300 mutually linked with regard to a specified place may be stored in the database 221. For example, a table (or a mapping table) associated with mapping between the IoT device 400 and the second electronic device 300 may be stored in the database 221. For example, the mapping table may be identical or similar to Table 1 above.

In various embodiments, the second memory 220 may provide the second electronic device 300 information associated with the IoT device 400 to the first electronic device 100_2 depending on a request of the first electronic device 100_2. In this case, the first electronic device 100_2 may extract information about the second electronic device 300 associated with the IoT device 400 from the mapping table stored in the database 221.

According to an embodiment, the second electronic device 300 may control the IoT device 400 depending on the control signal received from the first electronic device 100_2. For example, the second electronic device 300 may transmit the control signal by using a specified wavelength (e.g., an infrared wavelength) in a direction in which the IoT device 400 is disposed. The second electronic device 300 may include the sensor unit 310 capable of emitting the specified wavelength.

According to an embodiment, the sensor unit 310 may transmit a signal of a specified wavelength (e.g., an infrared wavelength) toward the IoT device 400. In this case, the control signal may be included in the signal of the specified wavelength transmitted from the sensor unit 310. In various embodiments, the sensor unit 310 may be an infrared sensor. Also, at least a portion of the sensor unit 310 may be exposed to the outside such that the emission of the specified wavelength toward the IoT device 400 is possible, and the exposed portion may be disposed to face the IoT device 400.

In various embodiments, the second electronic device 300 may include components that are identical or similar to those of the first electronic device 100_2. For example, in the case where the second electronic device 300 including components identical or similar to those of the first electronic device 100_2 obtains a sound signal (e.g., the sound signal 10 of FIG. 1) from the user, the second electronic device 300 may transmit the sound signal to the IoT server 200_2 such that a control for the IoT device 400 is possible.

In various embodiments, the second electronic device 300 may be connected with the IoT server 200_2 through an access point (e.g., a Wi-Fi router).

According to an embodiment, the IoT device 400 may operate under control of the second electronic device 300. For example, when the control signal of the specified wavelength is transmitted from the second electronic device 300, the IoT device 400 may operate (e.g., may be powered off) according to the control signal. In this case, the IoT device 400 may be linked to the second electronic device 300 with regard to a specified place.

In various embodiments, the IoT device 400 may transmit various kinds of operating information (e.g., state information, function information, and the like) to the first electronic device 100_2, the IoT server 200_2, the second electronic device 300, or a mobile communication terminal of the user in the form of a batch or a stream.

In various embodiments, the IoT device 400 may be an IoT technology-based service target (e.g., an electronic product).

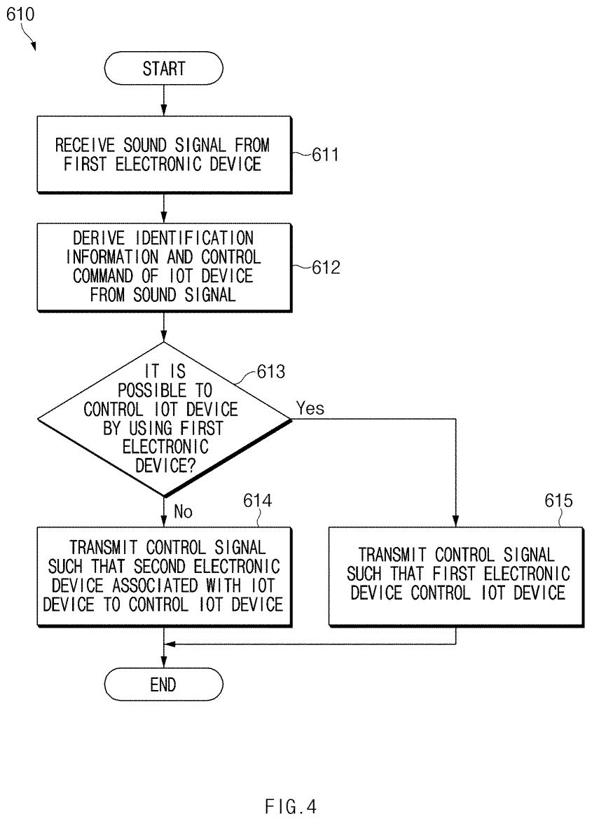

The above description given with reference to FIG. 3 with regard to the same reference numerals may be identically applied to FIG. 4.

FIG. 4 illustrates a process of controlling an IoT device, according to an embodiment.

Referring to FIG. 4, in an IoT environment (e.g., the IoT environment 1000 of FIG. 1) according to an embodiment, an IoT server (e.g., the IoT server 200 of FIG. 1) may allow a second electronic device (e.g., the second electronic device 300 of FIG. 1) to perform a control process 610 of an IoT device (e.g., the IoT device 400 of FIG. 1) by communicating with a first electronic device (e.g., the first electronic device 100 of FIG. 1) through the network 500 (e.g., the network 500 of FIG. 1).

Referring to operation 611, the IoT server 200 according to an embodiment may receive a sound signal (e.g., the sound signal 10 of FIG. 1) through the first electronic device 100.

Referring to operation 612, the IoT server 200 according to an embodiment may derive identification information and a control command of the IoT device 400 from the sound signal 10 received from the first electronic device 100.

Referring to operation 613, the IoT server 200 according to an embodiment may determine whether it is possible to control the IoT device 400 by using the first electronic device 100. For example, when it is determined in operation 613 that it is impossible to control the IoT device 400 by using the first electronic device 100, the IoT server 200 may perform operation 614. For another example, when it is determined in operation 613 that it is possible to control the IoT device 400 by using the first electronic device 100, the IoT server 200 may perform operation 615.

Referring to operation 614, the IoT server 200 according to an embodiment may transmit a control signal such that the second electronic device 300 associated with the IoT device 400 controls the IoT device 400. In this case, the IoT server 200 may allow the second electronic device 300, which is linked to the IoT device 400 with regard to a specified place, to control the IoT device 400.

Referring to operation 615, the IoT server 200 according to an embodiment may transmit a control signal such that the first electronic device 100 controls the IoT device 400. In an embodiment, in the case where the first electronic device 100 transmitting the sound signal 10 to the IoT server 200 is linked to the IoT device 400 with regard to the specified place, the IoT server 200 may transmit the control signal to the first electronic device 100.

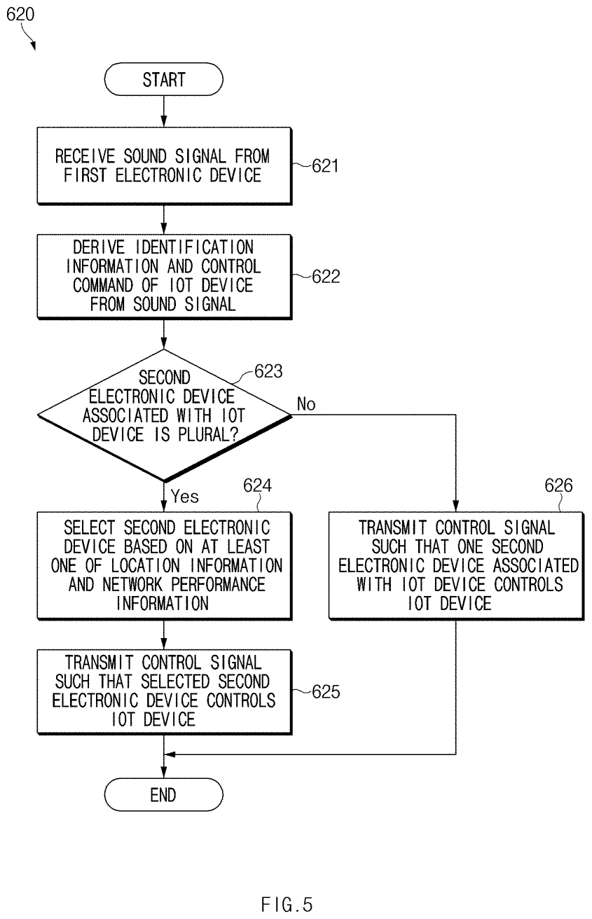

FIG. 5 illustrates a process of controlling an IoT device, according to an embodiment.

Referring to FIG. 5, in an IoT environment (e.g., the IoT environment 1000 of FIG. 1) according to an embodiment, an IoT server (e.g., the IoT server 200 of FIG. 1) may allow a second electronic device (e.g., the second electronic device 300 of FIG. 1) to perform a control process 620 of an IoT device (e.g., the IoT device 400 of FIG. 1) by communicating with a first electronic device (e.g., the first electronic device 100 of FIG. 1) through the network 500 (e.g., the network 500 of FIG. 1).

Referring to operation 621, the IoT server 200 according to an embodiment may receive a sound signal (e.g., the sound signal 10 of FIG. 1) through the first electronic device 100.

Referring to operation 622, the IoT server 200 according to an embodiment may derive identification information and a control command of the IoT device 400 from the sound signal 10 received from the first electronic device 100.

Referring to operation 623, the IoT server 200 according to an embodiment may determine whether the second electronic device 300 associated with the IoT device 400 is plural. For example, when it is determined that the second electronic device 300 associated with the IoT device 400 is not plural, the IoT server 200 may perform operation 626. For example, when it is determined that the second electronic device 300 associated with the IoT device 400 is plural, the IoT server 200 may perform operation 624.

Referring to operation 624, the IoT server 200 according to an embodiment may select one of the plurality of second electronic devices 300 associated with the IoT device 400 based on a variety of information. For example, the IoT server 200 may select one second electronic device 300 based on at least one of network performance information and location information about the IoT device 400. In various embodiments, the location information may be information for selecting the second electronic device 300, which is located within a shorter distance, from among the plurality of second electronic devices 300 associated with the IoT device 400. In various embodiments, the network performance information may be information for selecting the second electronic device 300, which is connectable to the network 500 or has a high communication efficiency for the network 500, from among the plurality of second electronic devices 300 associated with the IoT device 400.

Referring to operation 625, the IoT server 200 according to an embodiment may transmit a control signal such that the second electronic device 300 thus selected controls the IoT device 400.

Referring to operation 626, the IoT server 200 according to an embodiment may transmit a control signal such that the second electronic device 300 associated with the IoT device 400 controls the IoT device 400.

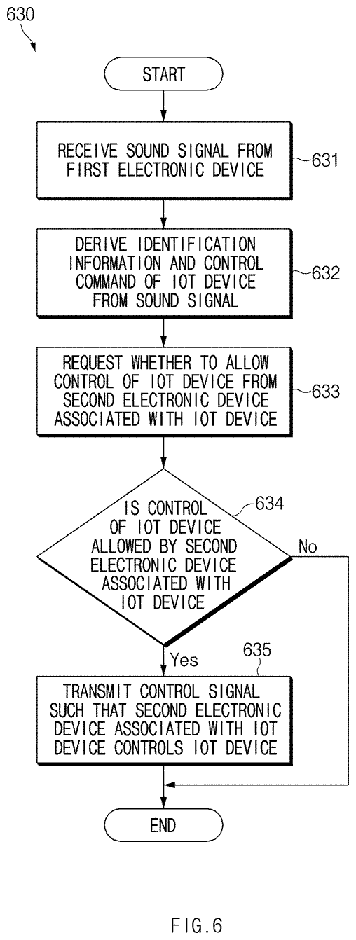

FIG. 6 illustrates a process of controlling an IoT device, according to an embodiment.

Referring to FIG. 6, in an IoT environment (e.g., the IoT environment 1000 of FIG. 1) according to an embodiment, an IoT server (e.g., the IoT server 200 of FIG. 1) may allow a second electronic device (e.g., the second electronic device 300 of FIG. 1) to perform a control process 630 of an IoT device (e.g., the IoT device 400 of FIG. 1) by communicating with a first electronic device (e.g., the first electronic device 100 of FIG. 1) through the network 500 (e.g., the network 500 of FIG. 1).

Referring to operation 631, the IoT server 200 according to an embodiment may receive a sound signal (e.g., the sound signal 10 of FIG. 1) through the first electronic device 100.

Referring to operation 632, the IoT server 200 according to an embodiment may derive identification information and a control command of the IoT device 400 from the sound signal 10 received from the first electronic device 100.

Referring to operation 633, the IoT server 200 according to an embodiment may have a request of the second electronic device 300 associated with the IoT device 400 for whether to allow a control of the IoT device 400. In this case, the IoT server 200 may have a request for whether to allow the control of the IoT device 400, depending on the control command derived from the sound signal 10.

Referring to operation 634, the IoT server 200 according to an embodiment may determine whether the second electronic device 300 associated with the IoT device 400 allows the control of the IoT device 400. For example, when it is determined in operation 634 that the control of the IoT device 400 is allowed by the second electronic device 300, the IoT server 200 may perform operation 635. For another example, when it is determined in operation 634 that the control of the IoT device 400 is not allowed by the second electronic device 300, the IoT server 200 may terminate the control process 630.

Referring to operation 635, the IoT server 200 according to an embodiment may transmit a control signal such that the second electronic device 300 associated with the IoT device 400 controls the IoT device 400. In this case, the IoT server 200 may allow the second electronic device 300, which is linked to the IoT device 400 with regard to a specified place, to control the IoT device 400.

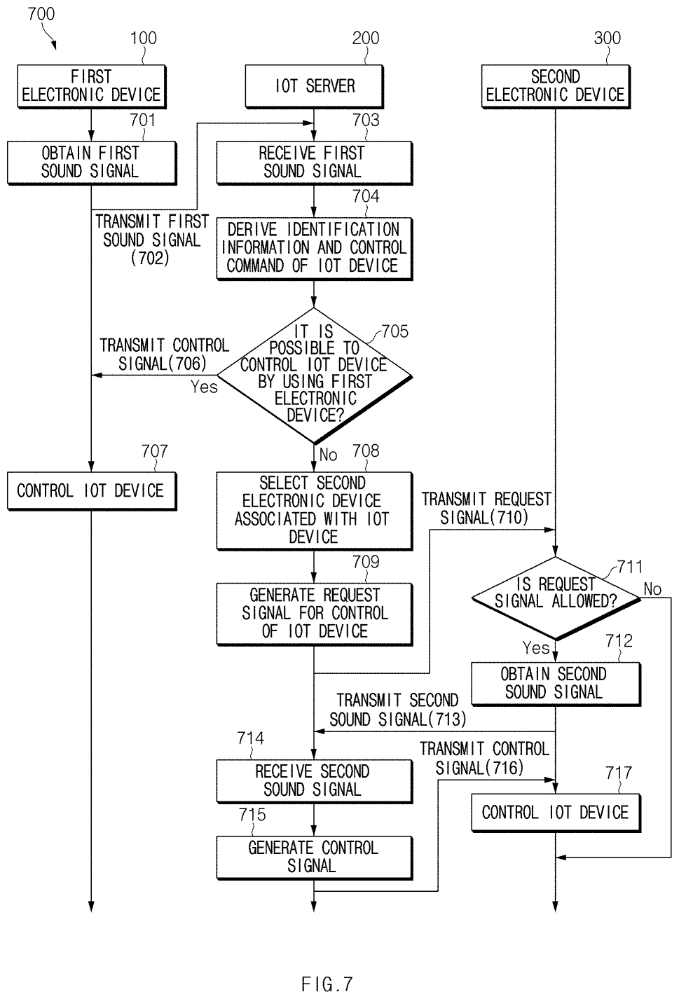

FIG. 7 illustrates a process of controlling an IoT device, according to various embodiments. At least one of components of an IoT environment (e.g., the IoT environment 1000 of FIG. 1) illustrated in FIG. 7 may be identical or similar to at least one of the components of the first electronic device 100_1, the IoT server 200_1, the second electronic device 300, and the IoT device 400 illustrated in FIG. 2, and thus, additional description will be omitted to avoid redundancy.

Referring to FIG. 7, in an IoT device control process 700 according to an embodiment, the IoT server 200 may communicate with the first electronic device 100 through the network 500 (e.g., the network 500 of FIG. 1) and may allow the second electronic device 300 to control the IoT device 400.

Referring to operation 701, the first electronic device 100 may obtain an input corresponding to an utterance of the user as a first sound signal (e.g., the sound signal 10 of FIG. 1). For example, the first electronic device 100 may obtain the first sound signal associated with a control command of the IoT device 400.

Referring to operation 702, the first electronic device 100 according to an embodiment may transmit the first sound signal to the IoT server 200.

Referring to operation 703, the IoT server 200 according to an embodiment may receive the first sound signal from the first electronic device 100.

Referring to operation 704, the IoT server 200 according to an embodiment may derive identification information and a control command of the IoT device 400 from the first sound signal.

Referring to operation 705, the IoT server 200 according to an embodiment may determine whether it is possible to control the IoT device 400 by using the first electronic device 100 transmitting the first sound signal to the IoT server 200. For example, when it is determined in operation 705 that it is possible to control the IoT device 400 by using the first electronic device 100, the IoT server 200 may perform operation 706. For another example, when it is determined in operation 705 that it is impossible to control the IoT device 400 by using the first electronic device 100, the IoT server 200 may perform operation 708.

Referring to operation 706, the IoT server 200 according to an embodiment may transmit a control signal corresponding to the control command to the first electronic device 100.

Referring to operation 707, the first electronic device 100 according to an embodiment may control an operation of the IoT device 400 depending on the control signal received from the IoT server 200. For example, the first electronic device 100 may be linked to the IoT device 400 with regard to a specified place.

Referring to operation 708, the IoT server 200 according to an embodiment may select the second electronic device 300 associated with the IoT device 400. For example, in the case where the second electronic device 300 associated with the IoT device 400 is plural, the IoT server 200 may select one second electronic device 300 based on at least one of network performance information and location information.

Referring to operation 709, the IoT server 200 according to an embodiment may generate a request signal for whether to allow a control of the IoT device 400.

Referring to operation 710, the IoT server 200 according to an embodiment may transmit the request signal to the second electronic device 300.

Referring to operation 711, the second electronic device 300 according to an embodiment may determine whether to allow the request signal received from the IoT server 200. For example, in the case where the second electronic device 300 allows the request signal in operation 711, the second electronic device 300 may perform operation 712 For another example, when the second electronic device 300 does not allow the request signal in operation 711, the IoT device control process 700 may be terminated. In this case, the second electronic device 300 may receive an utterance input of refusing the request signal from the user.

Referring to operation 712, the second electronic device 300 according to an embodiment may obtain an input corresponding to an utterance of the user as a second sound signal. For example, the second electronic device 300 may obtain the second sound signal associated with an allowance response to the request signal.

Referring to operation 713, the second electronic device 300 according to an embodiment may transmit the second sound signal to the IoT server 200.

Referring to operation 714, the IoT server 200 according to an embodiment may receive the second sound signal from the second electronic device 300.

Referring to operation 715, the IoT server 200 according to an embodiment may generate a control signal depending on the second sound signal. In this case, the IoT server 200 may derive a response of allowing a control of the IoT device 400 from the second sound signal. Also, the IoT server 200 may generate a control signal associated with the first sound signal received from the first electronic device 100.

Referring to operation 716, the IoT server 200 according to an embodiment may transmit the control signal to the second electronic device 300.

Referring to operation 717, the second electronic device 300 according to an embodiment may control the IoT device 400 depending on the control signal received from the IoT server 200. In this case, the second electronic device 300 may transmit the control signal to the IoT device 400 by using a specified wavelength (e.g., an infrared wavelength).

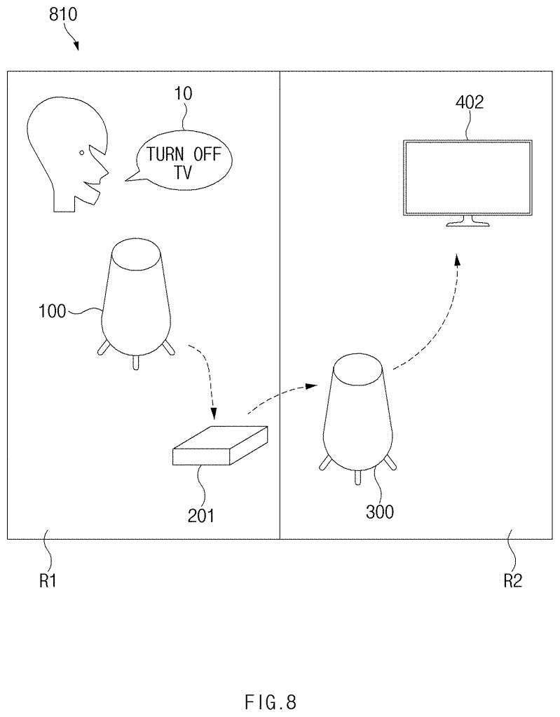

FIG. 8 illustrates an IoT device control environment according to an embodiment.

Referring to FIG. 8, in an IoT device control environment 810, when the first electronic device 100 obtains a sound signal associated with a control of an IoT device 402 from the user, the first electronic device 100 may allow the second electronic device 300 to control the IoT device 402.

According to an embodiment, the first electronic device 100 may obtain the sound signal 10 indicating “Turn off the TV” depending on an utterance input of the user. In this case, the first electronic device 100 may transmit the sound signal 10 to an IoT server (e.g., the IoT server 200 of FIG. 1) through an access point 201 (e.g., a Wi-Fi router). In various embodiments, the first electronic device 100 may be disposed in a first region R1 (e.g., a bedroom).

According to an embodiment, the second electronic device 300 may receive a control signal for the IoT device 402 from the IoT server 200 through the access point 201. In this case, the second electronic device 300 may be linked to the IoT device 402 with regard to a second space R2 (e.g., a living room). In various embodiments, the second electronic device 300 may transmit a control signal to the IoT device 402 by using a specified wavelength (e.g., an infrared wavelength).

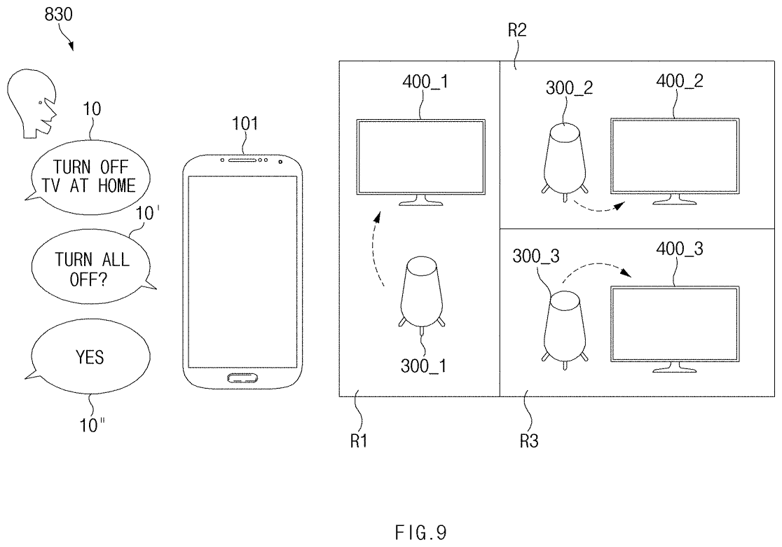

FIG. 9 illustrates an IoT device control environment according to an embodiment.

Referring to FIG. 9, in an IoT device control environment 830, when a first electronic device 101 obtains a sound signal associated with a control of an IoT device 400_1, 400_2, or 400_3 from the user, the first electronic device 101 may allow the second electronic device 300_1, 300_2, and 300_3 to control the IoT device 400_1, 400_2, or 400_3.

According to an embodiment, the first electronic device 101 may obtain the sound signal 10 indicating “Turn off the TV at home” depending on an utterance input of the user. In this case, the first electronic device 101 may transmit the sound signal 10 to an IoT server (e.g., the IoT server 200 of FIG. 1).

According to an embodiment, the first electronic device 101 may output the sound signal 10 indicating “Turn all off?” for the purpose of guiding an utterance input of the user.

According to an embodiment, the first electronic device 101 may obtain the sound signal 10 indicating “Yes” depending on the utterance input of the user. In this case, the first electronic device 101 may allow the IoT server 200 to perform operations for performing an operation corresponding to the sound signal 10 indicating “Turn off the TV at home”.

In various embodiments, the first electronic device 101 may be a mobile communication terminal of the user located at any other place other than a specified place (e.g., the first space R1, the second space R2, or a third space R3).

According to an embodiment, a second electronic device 300_1, 300_2, or 300_3 disposed at a specified place of each of the first space R1 (e.g., a living room), the second space R2 (e.g., a bedroom), and the third space R3 (e.g., a study) so as to correspond to an IoT device 400_1, 400_2, or 400_3 may receive a control signal from the IoT server 200. In various embodiments, the second electronic device 300_1, 300_2, or 300_3 may transmit the control signal to the IoT device 400_1, 400_2, or 400_3 by using a specified wavelength (e.g., an infrared wavelength).

According to an exemplary embodiment, a server (e.g., the IoT server 200_1 of FIG. 2) which supports an operation of an IoT environment may include a communication circuit (e.g., the second communication circuit 210 of FIG. 2), and a processor (e.g., the second processor 230 of FIG. 2) that is electrically connected with the communication circuit. The processor may receive a sound signal corresponding to an utterance input of a user from a first electronic device (e.g., the first electronic device 100_1 of FIG. 2) through the communication circuit, may derive identification information and a control command of an IoT device (e.g., the IoT device 400 of FIG. 2) from the sound signal, may determine whether it is possible to control the IoT device by using the first electronic device, and may transmit a control signal corresponding to the control command to a second electronic device (e.g., the second electronic device 300 of FIG. 2) associated with the IoT device based on a result of the determination such that the second electronic device controls the IoT device by using a specified wavelength.

The server (e.g., an IoT server) may further include a memory (e.g., the second memory 220 of FIG. 2), and the processor may store the IoT device and the second electronic device in the memory in association with a specified place.

For example, when the second electronic device associated with the IoT device includes a plurality of second electronic devices, the processor may select one of the plurality of second electronic devices based on at least one of location information about the IoT device and network performance information about the IoT device.

For example, the processor may transmit a request signal for a control of the IoT device to the second electronic device associated with the IoT device.

For example, the processor may transmit the control signal to the second electronic device depending on a response of the second electronic device to the request signal.

For example, the processor may receive a response associated with another sound signal from the second electronic device.

For example, when the identification information of the IoT device is plural, the processor may allow the second electronic device to transmit the control signal to an IoT device selected from the first electronic device.

For example, the processor may allow the second electronic device to transmit the control signal to the IoT device by using a specified wavelength corresponding to an infrared wavelength.

According to an embodiment, an electronic device (e.g., the first electronic device 100_1 of FIG. 2) which supports an operation of an IoT environment may include a communication circuit (e.g., the first communication circuit 120 of FIG. 2), and a processor (e.g., the first processor 140 of FIG. 1) that is electrically connected with the communication circuit. The processor may transmit a sound signal corresponding to an utterance input of a user to a server (e.g., the IoT server 200_1 of FIG. 2) through the communication circuit, and may allow the server to transmit a control signal corresponding to the control command to another electronic device (e.g., the second electronic device 300 of FIG. 2) associated with the IoT device, depending on it is possible to control the IoT device corresponding to the derived identification information by using the electronic device, when identification information and a control command of an IoT device (e.g., the IoT device 400 of FIG. 2) are derived from the sound signal by the server.

For example, the processor may control the server such that the other electronic device controls the IoT device by using a specified wavelength.

For example, when the electronic device fails to transmit a specified wavelength, the processor may allow the server to transmit the control signal to the other electronic device.

For example, the electronic device may further include a speaker (e.g., the speaker 150 of FIG. 2). The processor may output whether to transmit the control signal by using the speaker.

For example, the sound signal corresponds to at least one of at least one syllable, a word in which the at least one syllable is included, or a sentence in which the word is included.

According to an embodiment, a method for controlling an IoT device may include receiving a sound signal corresponding to an utterance input of a user from a first electronic device, deriving identification information and a control command of the IoT device from the sound signal, determining whether it is possible to control the IoT device by using the first electronic device, and transmitting a control signal corresponding to the control command to a second electronic device associated with the IoT device based on a result of the determination such that the second electronic device controls the IoT device by using a specified wavelength.

The method may further include storing the IoT device and the second electronic device in a memory in association with a specified place.

When the second electronic device associated with the IoT device includes a plurality of second electronic devices, the processor may select one of the plurality of second electronic devices based on at least one of location information about the IoT device and network performance information about the IoT device.

The method may further include transmitting a request signal for a control of the IoT device to the second electronic device associated with the IoT device.

The method may further include transmitting the control signal to the second electronic device depending on a response of the second electronic device to the request signal.

The method may further include receiving a response associated with another sound signal from the second electronic device.

The method may further include allowing the second electronic device to transmit the control signal to an IoT device selected from the first electronic device, when the identification information of the IoT device is plural.

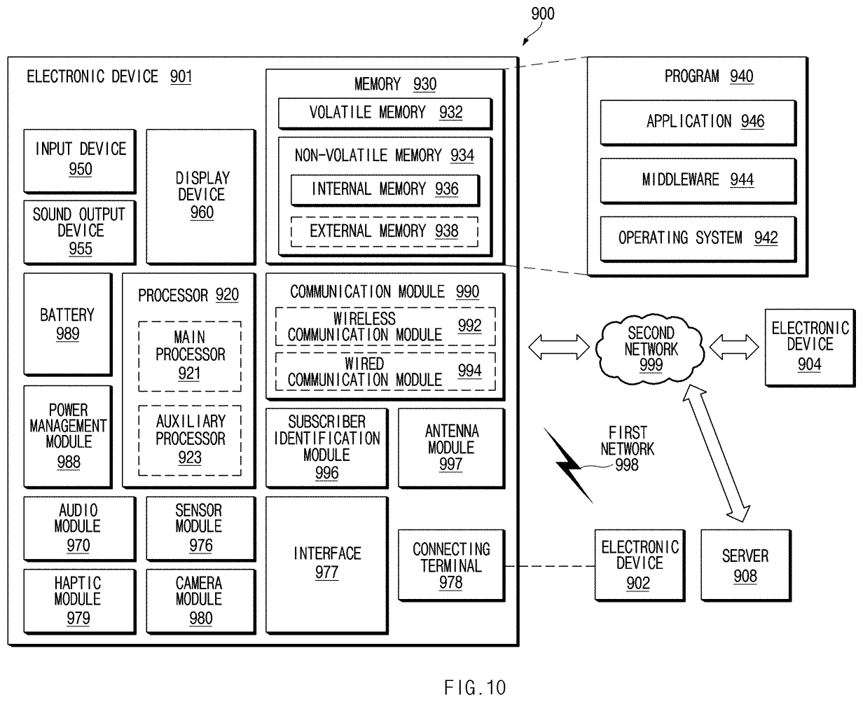

FIG. 10 is a block diagram illustrating an electronic device 901 in a network environment 1000 according to various embodiments. Referring to FIG. 10, the electronic device 901 in the network environment 900 may communicate with an electronic device 902 via a first network 998 (e.g., a short-range wireless communication network), or an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) 996, or an antenna module 997. In some embodiments, at least one (e.g., the display device 960 or the camera module 980) of the components may be omitted from the electronic device 901, or one or more other components may be added in the electronic device 901. In some embodiments, some of the components may be implemented as single integrated circuitry. For example, the sensor module 976 (e.g., a fingerprint sensor, an iris sensor, or an illuminance sensor) may be implemented as embedded in the display device 960 (e.g., a display).

The processor 920 may execute, for example, software (e.g., a program 940) to control at least one other component (e.g., a hardware or software component) of the electronic device 901 coupled with the processor 920, and may perform various data processing or computation. According to one embodiment, as at least part of the data processing or computation, the processor 920 may load a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by other component (e.g., the processor 920) of the electronic device 901, from the outside (e.g., a user) of the electronic device 901. The input device 950 may include, for example, a microphone, a mouse, a keyboard, or a digital pen (e.g., a stylus pen).

The sound output device 955 may output sound signals to the outside of the electronic device 901. The sound output device 955 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. According to an embodiment, the display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. According to an embodiment, the audio module 970 may obtain the sound via the input device 950, or output the sound via the sound output device 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to one embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., PCB). According to an embodiment, the antenna module 997 may include a plurality of antennas. In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 and 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 11 illustrates a device registration and control system 1100 according to various embodiments.

Referring to FIG. 11, the device registration and control system 1100 may include a first electronic device 1110, the first IoT server 1120, a second electronic device 1130, an external electronic device 1140, a DB server 1150, an antenna server 1160, and/or the sound signal processing server 1170.

According to an embodiment, the first electronic device 1110 (e.g., the first electronic device 100 of FIGS. 1 to 9 or the electronic device 901 of FIG. 10) may be a device that stores identification information of various external electronic devices 1140 (e.g., first identification information including information about an external electronic device) and controls the external electronic device 1140 (e.g., the IoT device 400 of FIGS. 1 to 9) by using the second electronic device 1130 (e.g., the second electronic device 300 of FIGS. 1 to 9). The first electronic device 1110 may allow the first IoT server 1120 to transmit a signal for controlling the external electronic device 1140 to the second electronic device 1130. For example, the first electronic device 1110 may identify an operation (e.g., a power ON/OFF, a channel change, and/or a volume control) of the external electronic device 1140. For example, the first electronic device 1110 may identify an operation for a control of the external electronic device 1140 by using an external electronic device managing app.

According to an embodiment, the first electronic device 1110 may identify an operation that is supported by the external electronic device 1140 in the process of registering the external electronic device 1140 at the external electronic device managing app. For example, the first electronic device 1110 may obtain information (e.g., a model name, a type, and/or a manufacturer of the external electronic device 1140) of the external electronic device 1140 in the process of registering the external electronic device 1140 at the external electronic device managing app of the first electronic device 1110 and/or the first IoT server 1120. The first electronic device 1110 may obtain information of the external electronic device 1140 based on a user input. For example, the first electronic device 1110 may transfer the information of the external electronic device 1140 to the second electronic device 1130 through the first IoT server 1120, and the second electronic device 1130 may obtain information about an operation, which is supported by the external electronic device 1140 and corresponds to the information of the external electronic device 1140, from the DB server 1150. The second electronic device 1130 may transfer information for a control of the external electronic device 1140 (e.g., information of an operation supported by the external electronic device 1140 and/or information about a signal of a specified wavelength necessary for a control of the external electronic device 1140) through the first IoT server 1120. For another example, the first electronic device 1110 may obtain information for a control of the external electronic device 1140 (e.g., information of an operation supported by the external electronic device 1140 and/or information about a signal of a specified wavelength necessary for a control of the external electronic device 1140) through the first IoT server 1120 or directly from the DB server 1150. For example, the DB server 1150 may include a database for a plurality of electronic devices. The database of the DB server 1150 may include information (e.g., a model name, a manufacturer, and/or an identification number) about an electronic device and information about an operation (e.g., information of a supported operation and information about a signal of a specified wavelength necessary to perform the supported operation) supported by the electronic device.

According to an embodiment, the first electronic device 1110 may further obtain additional information about the external electronic device 1140 in the process of registering the external electronic device 1140 (e.g., a TV or a set-top box) of a specific type. For example, the first electronic device 1110 may obtain information (e.g., content provider information) about the external electronic device 1140 through the antenna server 1160. The first electronic device 1110 may obtain content provider information (e.g., a name of a content provider) providing content to the external electronic device 1140 from the antenna server 1160 based on at least one of a user input, location information of the first electronic device 1110, or location information of the second electronic device 1130. The additional information of the external electronic device 1140 may be stored in the first IoT server 1120 in association with the external electronic device 1140.

According to an embodiment, the first IoT server 1120 may include a memory, a communication circuit, a processor, or the like therein. For example, the first IoT server 1120 may share and transfer information about the external electronic device 1140, IoT environment information, and the like between the first electronic device 1110 and the second electronic device 1130. The first IoT server 1120 may store information about the first electronic device 1110 and the external electronic device 1140, which is registered at the external electronic device managing app operating at the first electronic device 1110, and information of an external electronic device not added, independently of each other.

According to an embodiment, the sound signal processing server 1170 may be configured to receive a sound command signal and information about the sound command signal from the first electronic device 1110 and/or the second electronic device 1130 and to process the received sound command signal and information. For example, the sound signal processing server 1170 may perform operations corresponding to the ASR module 231, the NLU module 232, and the selector module 233 described with reference to FIG. 2. An example is illustrated in FIG. 11 as the sound signal processing server 1170 and the first IoT server 1120 are independent of each other, but embodiments of the disclosure are not limited thereto. For example, the sound signal processing server 1170 and the first IoT server 1120 may be implemented with one server (e.g., the IoT server 200 of FIG. 7). For example, the first electronic device 1110 may receive a sound command from the user and may transmit a sound signal or information corresponding to the sound command to the sound signal processing server 1170. The sound signal processing server 1170 may process the received sound signal or the received information and may transfer the processed result to the first IoT server 1120. For example, the sound signal or the information may include a command for a control of any other electronic device (e.g., the external electronic device 1140). In this case, the first IoT server 1120 may identify the external electronic device 1140 targeted for a control and a control operation based on the information received from the sound signal processing server 1170 and may transmit information, which causes the second electronic device 1130 to perform the control operation, to the second electronic device 1130. The second electronic device 1130 may allow the external electronic device 1140 to perform the above control operation by radiating a control signal (e.g., a signal of a specified frequency) corresponding to the received information.

As in the above description, the IoT server 1120 may receive a command for a control based on an input that corresponds to an utterance of the user received from the first electronic device 1110 and/or the second electronic device 1130 and is processed by the sound signal processing server 1170. After the first IoT server 1120 receives the command for the control, the first IoT server 1120 may control an operation of the external electronic device 1140 based on information about the external electronic device 1140. For example, a command for a control of the external electronic device 1140 may include content identification information (e.g., a content provider name, a channel, and/or a content name). In this case, the first IoT server 1120 may identify an operation corresponding to the control command through the antenna server 1160 based on the content provider information about the external electronic device 1140. For example, the first IoT server 1120 may obtain content information (e.g., video on demand information and/or organizational table information) corresponding to the content provider information about the external electronic device 1140 from the antenna server 1160 or an Internet and may identify a control operation of the external electronic device 1140 by using the content identification information corresponding to the control command. For example, in the case where a sound command includes a name of a specific program, the first IoT server 1120 may identify channel and/or time information about broadcasting of a specific program based on information (e.g., first identification information including information about an external electronic device) of the external electronic device 1140. The first IoT server 1120 may allow the second electronic device 1130 to radiate a control signal such that the external electronic device 1140 is capable of receiving the corresponding program based on the identified channel and/or time information.

According to an embodiment, the second electronic device 1130 (e.g., an AI speaker) may receive, from the first IoT server 1120, the control signal and/or the control instruction transmitted from the first electronic device 1110 to the first IoT server 1120. In various embodiments, the second electronic device 1130 may control the external electronic device 1140 by using a specified wavelength (e.g., an infrared wavelength) associated with the control signal and/or the control instruction thus received. For example, the second electronic device 1130 may obtain an input corresponding to an utterance of the user as a sound signal and may transmit the obtained sound signal to the sound signal processing server 1170. The sound signal processing server 1170 may derive identification information and a control instruction of a device from the received sound signal and may transmit the derived result to the first IoT server 1120. The second electronic device 1130 may obtain information (e.g., manufacturer information, model information, instruction information, a control signal, and/or a control instruction (e.g., a device type, a code-set name, code-key information, or information of a specified wavelength) of the external electronic device 1140 through the DB server 1150. The second electronic device 1130 may identify the external electronic device 1140 targeted for a control, based on the obtained information.

According to an embodiment, the external electronic device 1140 (e.g., a TV, a set-top box, an electric fan, an air conditioner, an air cleaner, a robot cleaner, a lighting device, or the like) may perform an operation (e.g., power ON/OFF, a channel change, and/or a volume control) corresponding to a control signal that the second electronic device 1130 transmits. The external electronic device 1140 may receive the control signal, which is based on a specified wavelength (e.g., an infrared wavelength), from the second electronic device 1130.

According to an embodiment, the DB server 1150 may include a memory, a communication circuit, a processor, or the like therein. The DB server 1150 may store information (e.g., manufacturer information, model information, instruction information, a control signal and/or a control instruction (e.g., a device type, a code-set name, code-key information), or information of a specified wavelength) of the external electronic device 1140 in a memory. For example, when the DB server 1150 receives a signal requesting information of the external electronic device 1140 from the second electronic device 1130, the DB server 1150 may transmit DB information including the information to the second electronic device 1130. The second electronic device 1130 may store the received DB information in a memory.

According to an embodiment, the antenna server 1160 may include a memory, a communication circuit, a processor, or the like therein. The antenna server 1160 may store information (e.g., TV service provider information) about the external electronic device 1140 in the memory. For example, in the case where the external electronic device 1140 that the first electronic device 1110 intends to add to the external electronic device managing app is a TV or a set-top box, the antenna server 1160 may directly transmit, to the first electronic device 1110, information necessary in the process (e.g., location setting or TV service provider setting) where the first electronic device 1110 adds the external electronic device 1140 through the external electronic device managing app. For example, the antenna server 1160 may transmit information including information about the external electronic device 1140 to the first electronic device 1110 through the first IoT server 1120. For example, the antenna server 1160 may transmit information (e.g., channel information, content information, or genre information) about an input corresponding to an utterance of the user to the first IoT server 1120.

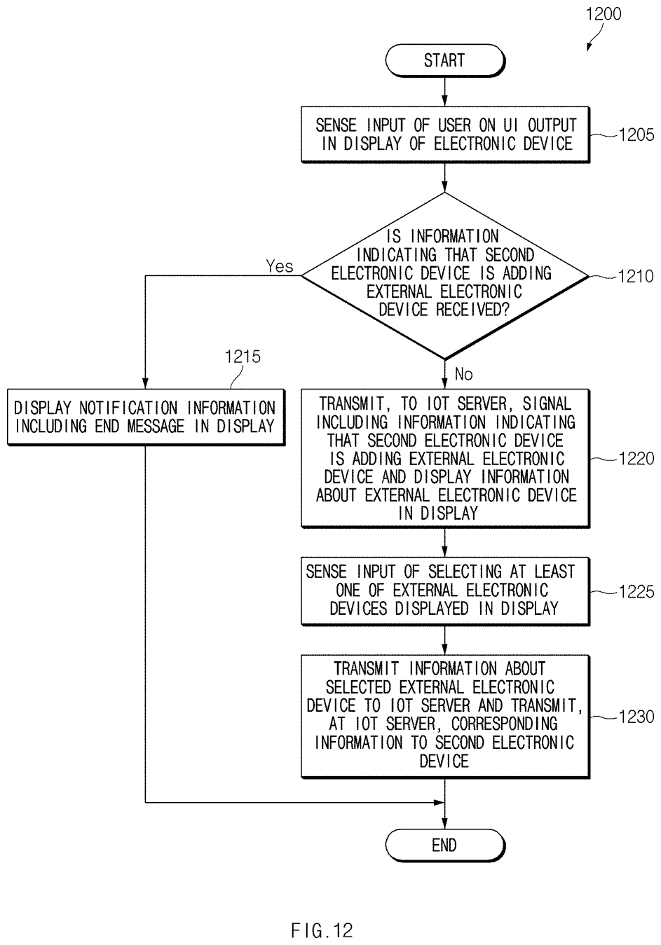

FIG. 12 illustrates a flowchart 1200 of a device registration method using an external electronic device managing app of an electronic device according to various embodiments.

Referring to FIG. 12, according to an embodiment, in operation 1205, an electronic device (e.g., the first electronic device 1110 of FIG. 11) may sense a selection input for selecting a second electronic device (e.g., the second electronic device 1130 of FIG. 11) through a display. For example, the selection input for selecting the second electronic device may be a touch input of the user sensed through a user interface output in the display. The user interface may include information (e.g., an external electronic device list and a guide phrase for registration of an external electronic device) for controlling an external electronic device.

According to an embodiment, in operation 1210, the electronic device may receive, from a first IoT server (e.g., the first IoT server 1120 of FIG. 11), information indicating that the second electronic device is registering the external electronic device by the second user.

According to an embodiment, when the electronic device receive the information indicating that the second electronic device is registering the external electronic device (e.g., Yes in operation 1210), the electronic device may perform operation 1215.

In operation 1215, the electronic device may display notification information including an end message of the user interface in the display. The notification information may further include information indicating that an external user is using the user interface.

According to an embodiment, when the electronic device does not receive the information indicating that the second electronic device is registering the external electronic device (e.g., No in operation 1210), the electronic device may perform operation 1220.

In operation 1220, the electronic device may transmit, to the IoT server, a signal including the information indicating that the second electronic device is registering the external electronic device and may display information about the external electronic device in the display. The information about the external electronic device may further include a kind of an external electronic device (e.g., a TV, a set-top box, an electric fan, an air fryer, or a lighting device) that the user intends to add and brand information of the external electronic device.

According to an embodiment, in operation 1225, the electronic device may sense an input of selecting at least one of external electronic devices displayed in the display. For example, the input of selecting at least one of the external electronic devices may be a touch input of the user.

According to an embodiment, in operation 1230, the electronic device may transmit a signal including information about the external electronic device selected by the input to the IoT server. The IoT server may transmit the information about the external electronic device to the second electronic device (e.g., the second electronic device 1130 of FIG. 11). The IoT server may store the information about the selected external electronic device and information about an unselected external electronic device based on the received signal, independently of each other.

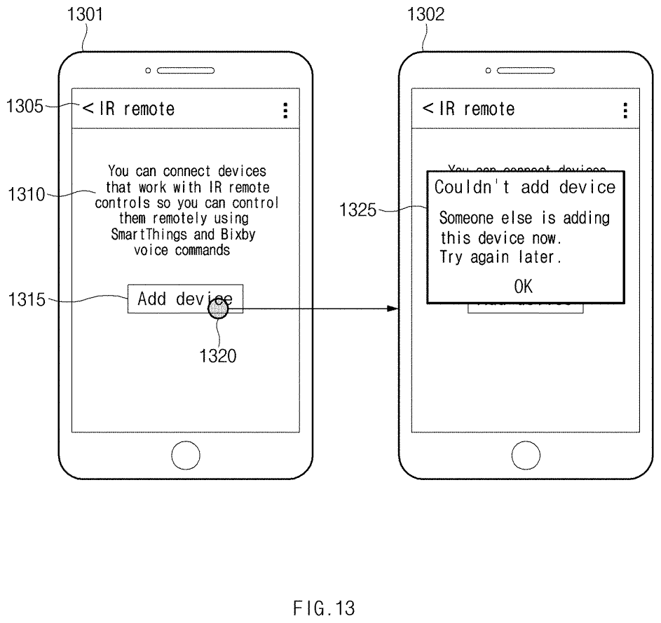

FIG. 13 illustrates a user interface screen that is output when a second user is using a registration step user interface of an external electronic device, according to various embodiments.

Referring to FIG. 13, according to an embodiment, in screen 1301, an electronic device (e.g., the first electronic device 1110 of FIG. 11) may output a user interface for registration of an external electronic device (e.g., the external electronic device 1140 of FIG. 11) in a display. For example, a user interface 1305 in which a previous button for returning to a previous screen, a sentence indicating a summary of contents of a current screen, and a button for providing a control function of any other external electronic device managing app are included may be provided at the top of screen 1301. For example, a guide message necessary to add the external electronic device to a second electronic device (e.g., the second electronic device 1130 of FIG. 11) may be included in screen 1301. For example, a button 1315 for switching into a screen showing a list of external electronic devices to be registered (or to be added) may be included in screen 1301. In the case where the second user is using the user interface, when a user input 1320 on the button 1315 is sensed, screen 1302 may be output in the display.

According to an embodiment, in screen 1302, a message 1325 in which information indicating that the second user is registering the external electronic device at the second electronic device is included may be output in the display. The message may further include notification information including an end message of the user interface.

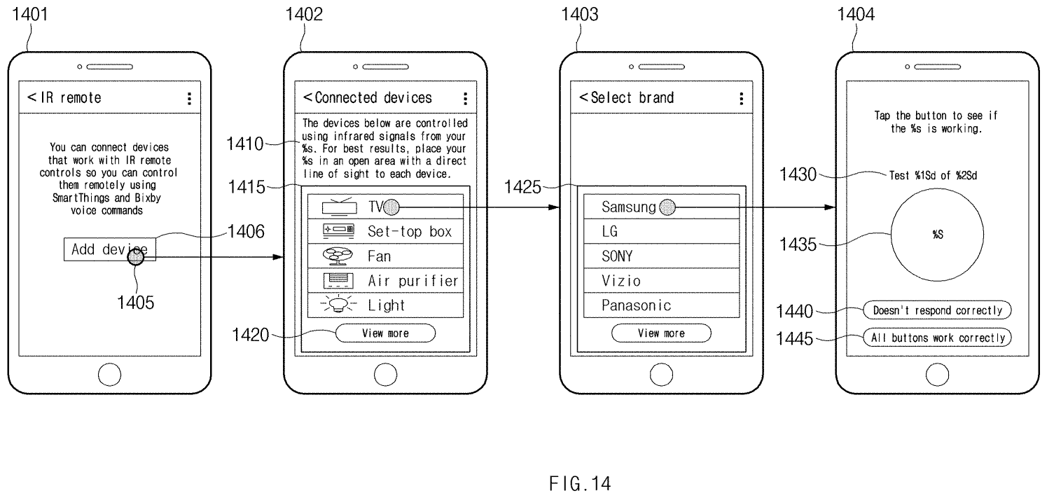

FIG. 14 illustrates a user interface screen that is output when an external user is using a registration step user interface of an external electronic device managing app, according to various embodiments;

Referring to FIG. 14, according to an embodiment, in screen 1401, an electronic device (e.g., the first electronic device 1110 of FIG. 11) may output a user interface for registration of an external electronic device (e.g., the external electronic device 1140 of FIG. 11) in a display. For example, a button 1406 for switching into a screen showing a list of external electronic devices to be registered may be included in screen 1401. In the case where the external user is using the user interface, when a user input 1405 on the button 1406 is sensed, the display may output screen 1402.

According to an embodiment, in screen 1402, the electronic device may output a message 1410 in which contents guiding the notice in the process of controlling the external electronic device is included. The electronic device may output a screen in which a device kind list 1415 of external electronic devices targeted for a control is included. For example, device kinds (e.g., a TV, a set-top box, an electric fan, an air fryer, and a lighting device) of external electronic devices that are registered at the electronic device and are capable being controlled through an external electronic device managing app may be included in the list 1415. An add button 1420 for further showing any other kind(s) except for the device kinds of external electronic devices output in the list 1415 may be further included in the screen 1402. For example, in the case where a user input on at least one of the device kinds of external electronic devices in the list 1415 is sensed, the display may output screen 1403.

According to an embodiment, in screen 1403, the electronic device may output a screen in which a brand list 1425 (e.g., SAMSUNG, LG, SONY, VIZIO, and PANASONIC) associated with the selected external electronic device is included. For example, in the case where a user input (e.g., a touch input) on at least one of brand kinds of the list 1425 is sensed, the display may output screen 1404.

According to an embodiment, in screen 1404, the electronic device may output a user interface of testing whether the selected external electronic device operates normally, based on the user inputs sensed in screen 1402 and screen 1403. For example, a message 1430 in which names of an external electronic device selected by an input of the user and a separate electronic device (e.g., the second electronic device 1130 of FIG. 11) (e.g., an AI speaker) receiving a control signal of the electronic device are included may be output in the user interface. For example, an illustration 1435 corresponding to an external electronic device targeted for a control may be output in the user interface. For example, a button 1440 corresponding to the case where the external electronic device is not correctly controlled by the separate electronic device receiving the control signal of the electronic device and/or a button 1445 corresponding to the case where the external electronic device is correctly controlled by the separate electronic device may be included in the user interface. For example, when a user input on the button 1440 corresponding to the case where the external electronic device is not correctly controlled is sensed, the electronic device may again determine whether the external electronic device operates, by using a user interface of testing any other function except for the user interface. For example, when a user input on the button 1445 corresponding to the case where the external electronic device is correctly controlled is sensed, the electronic device may complete the test associated with whether to operate and may close the user interface.

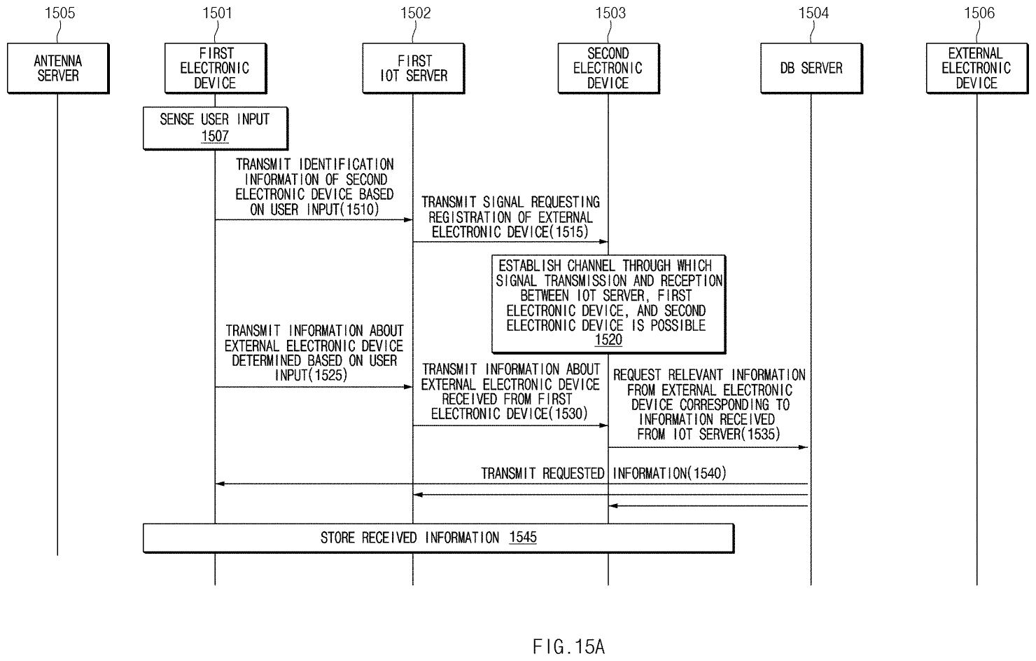

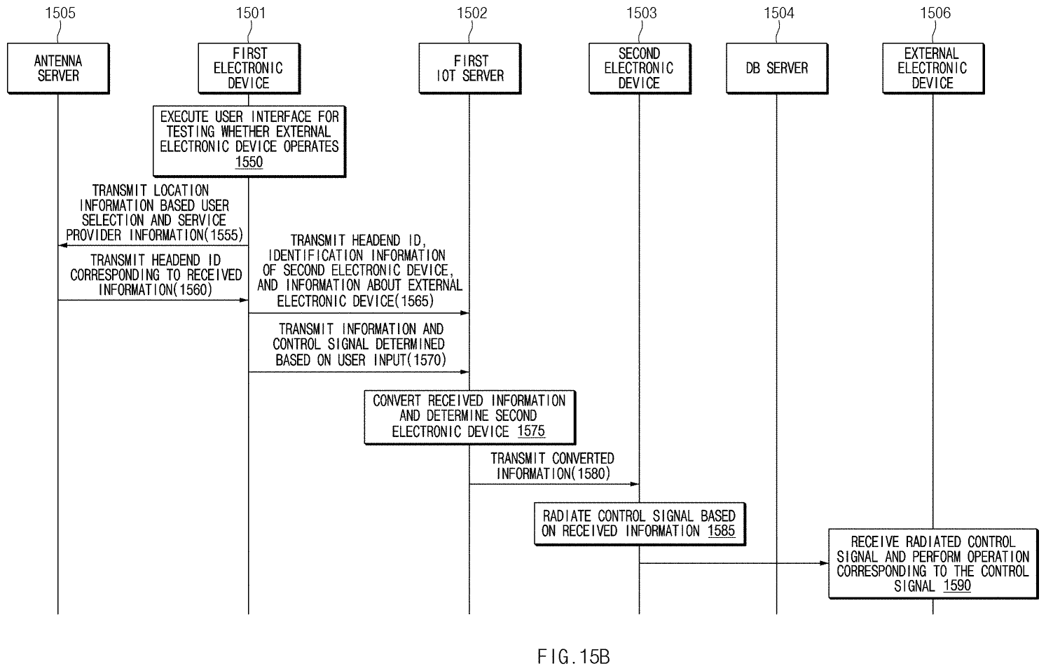

FIGS. 15A and 15B illustrate an overall flowchart of a registration system according to various embodiments;

Referring to FIGS. 15A and 15B, according to an embodiment, in operation 1507, a first electronic device 1501 (e.g., the first electronic device 1110 of FIG. 11) may sense an input of the user. For example, the user input may be sensed on a display outputting a user interface. The user input may include an operation of selecting at least one of icons of a second electronic device 1503 (e.g., the second electronic device 1130 of FIG. 11) included in the user interface and an operation of selecting at least one of icons corresponding to an external electronic device 1506 (e.g., the external electronic device 1140 of FIG. 11).

According to an embodiment, in operation 1510, the first electronic device 1501 may transmit identification information (e.g., second identification information including information about the second electronic device 1503) of the second electronic device 1503 determined based on the user input to a first IoT server 1502 (e.g., the first IoT server 1120 of FIG. 11).

According to an embodiment, in operation 1515, the first IoT server 1502 may register the external electronic device 1506 at an external electronic device managing app stored in the first electronic device 1501 and may transmit a signal requesting a remote control through the second electronic device 1503 to the second electronic device 1503.

According to an embodiment, in operation 1520, the second electronic device 1503 may receive the signal requesting registration of the external electronic device 1506 from the first IoT server 1502 and may then establish a channel through which signal transmission and reception between the first electronic device 1501, the first IoT server 1502, and the second electronic device 1503 is possible.

According to an embodiment, in operation 1525, the first electronic device 1501 may transmit information about the external electronic device 1506 (e.g., the external electronic device 1140 of FIG. 11) determined based on the user input. For example, the information about the external electronic device 1506 may include identification information of the external electronic device 1506 selected in operation 1525 (e.g., first identification information including information about an external electronic device).

According to an embodiment, in operation 1530, the first IoT server 1502 may transmit the information about the external electronic device 1506 received from the first electronic device 1501 to the second electronic device 1503.

According to an embodiment, in operation 1535, the second electronic device 1503 may have a request to a DB server 1504 for additional information of the external electronic device 1506 corresponding to the information about the external electronic device 1506 received from the first IoT server 1502. For example, the additional information about the external electronic device 1506 may include device kinds (e.g., a TV, a set-top box, an electric fan, an air conditioner, an air fryer, and a lighting device) of the external electronic device 1506, brand information, a control signal and/or a control instruction (e.g., a device type, a code-set name, code-key information), information of a specified wavelength, or the like.

According to an embodiment, in operation 1540, the DB server 1504 may transmit the additional information (e.g., instruction information or control signal information (e.g., a device type, a code-set name, or code-key information) about the external electronic device 1506 requested from the second electronic device 1503 to the first electronic device 1501, the first IoT server 1502, and the second electronic device 1503.

According to an embodiment, in operation 1545, each of the first electronic device 1501, the first IoT server 1502, and the second electronic device 1503 may store the information received from the DB server 1504 in a memory.

In operation 1550, the first electronic device 1501 may execute a user interface for testing whether the external electronic device 1506 operates. The user interface may be implemented through the first electronic device 1501, the first IoT server 1502, the second electronic device 1503, the external electronic device 1506, and an antenna server 1505. For example, when a user touch input on a button of the user interface is sensed, based on the received information, the first electronic device 1501 may transmit, to the first IoT server 1502, identification information (e.g., second identification information including information about the second electronic device 1503 such as identification information of an AI speaker) of the second electronic device 1503, identification information (e.g., first identification information including information about an external electronic device) of the external electronic device 1506, and/or a control signal and/or a control instruction (e.g., a device type, a code-set name, code-key information), or information of a specified wavelength. The first IoT server 1502 may transmit the identification information (e.g., the first identification information including information about an external electronic device) of the external electronic device 1506 and the control signal and/or the control instruction to the second electronic device 1503 selected based on the received information. The second electronic device 1503 may control the external electronic device based on the control signal and/or the control instruction thus received. The user may determine, through the test process, whether the external electronic device 1506 operates and may input a result of the determination to the first electronic device 1501. The input may be a touch input sensed on a button (e.g., the button 1440 or 1445 of FIG. 14) of an interface output at the first electronic device 1501.

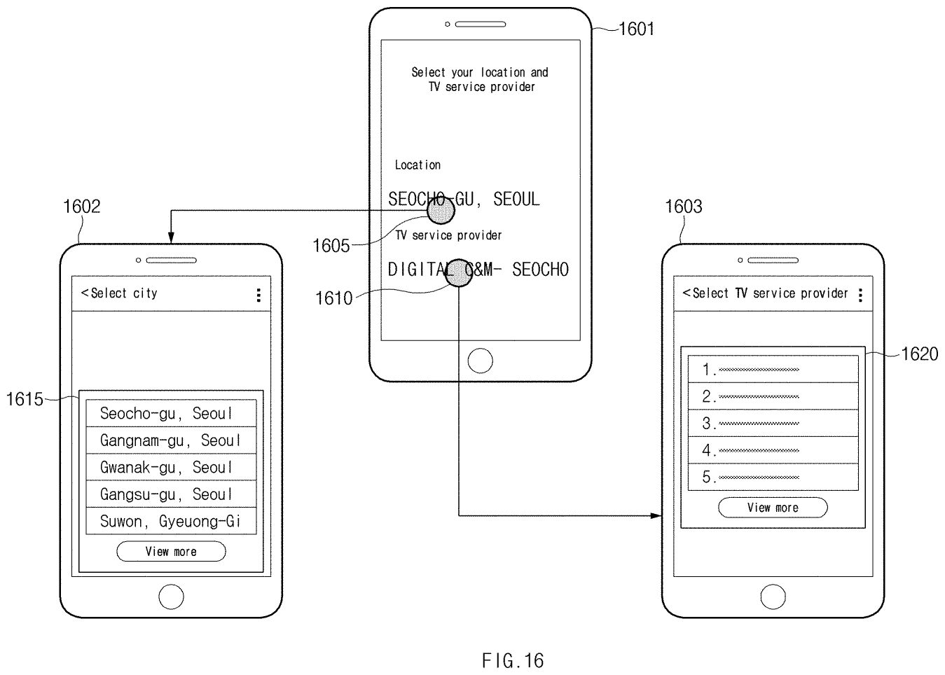

According to an embodiment, in operation 1555, the first electronic device 1501 may transmit location information based on selection of the user, and/or service provider information to the antenna server 1505. Contents determining the location information and/or the service provider information may be referenced through a user interface illustrated in FIG. 16.

In operation 1560, the antenna server 1505 may transmit a headendID determined by using the information received from the first electronic device 1501.

In operation 1565, the first electronic device 1501 may transmit, to the first IoT server 1502, the headendID received from the antenna server 1505 for registration of the external electronic device 1506, identification information (e.g., the first identification information) of the external electronic device 1506, identification information (e.g., the second identification information) of the second electronic device 1503 associated with the external electronic device 1506, and information (e.g., a device type or device information) about the external electronic device 1506. For example, the first IoT server 1502 may store the received pieces of information in a memory.

According to an embodiment, in operation 1570, the first electronic device 1501 may receive an input (e.g., a touch input touching a button for TV ON/OFF, a volume control, and/or a channel change) for control of the external electronic device 1506 from the user. The first electronic device 1501 may transmit the identification information (e.g., the first identification information) of the external electronic device 1506, the control signal determined based on the received input, and/or the control instruction (e.g., OCF data).

In operation 1575, the first IoT server 1502 may convert the received control signal and/or the received control instruction into a device type, a code-set name, and code-key information and may determine the second electronic device 1503 based on the identification information (e.g., the second identification information) of the second electronic device 1503 associated with the external electronic device 1506.

In operation 1580, the first IoT server 1502 may transmit the information (e.g., a device type, a code-set name, and code-key information) converted based on the control signal and/or the control instruction to the second electronic device 1503 thus determined. For example, the second electronic device 1503 may store the received pieces of information in a memory.

In operation 1585, the second electronic device 1503 may generate a control signal, which is based on a specified wavelength (e.g., an infrared wavelength), by using the converted information received from the first IoT server 1502. The second electronic device 1503 may transmit the control signal to the external electronic device 1506. For example, the second electronic device 1503 may allow the external electronic device 1506 to perform the above control operation by radiating a control signal (e.g., a signal of a specified frequency) corresponding to the received information.

FIG. 16 illustrates an additional user interface when an external electronic device to be registered at an electronic device is a TV or a set-top box, according to various embodiments.

According to various embodiments, in screen 1601, a user interface may include a location tap 1605, and/or a TV service provider tap 1610.

The user may set a current location of the user through the location tap 1605. Before an input of the user is made, basically, an electronic device (e.g., the first electronic device 1110 of FIG. 11) may in advance set and display a current location where the user is using the electronic device, by using a GPS function. When a user input (e.g., a touch input) on the location tap 1605 is sensed, screen 1602 may be output in a display.

Through the TV service provider tap 1610, the user may set a service provider of an external electronic device (e.g., a TV or a set-top box) to be controlled by the electronic device. Before an input of the user is made, the electronic device may in advance set and display the TV service provider automatically determined based on the default location information set by using the GPS function. When a user input (e.g., a touch input) on the TV service provider tap 1610 is sensed, screen 1603 may be output in the display.

According to an embodiment, in screen 1602, the user interface may include a location list 1615 for location setting of the electronic device. The location list 1615 may be updated based on a history of the electronic device that the user uses.

According to an embodiment, in screen 1603, the user interface may include a service provider list 1620 for an external electronic device (e.g., a TV or a set-top box) to be controlled. The service provider list 1620 may be updated based on a usage history of the user or may be synchronized based on the location information of the electronic device. For example, when a user input of selecting the external electronic device, the location information, and/or the service provider is sensed, the electronic device may transmit a signal including information about the selected contents to the antenna server 1160. The antenna server 1160 may transmit identification information (e.g., a headendID) determined based on the received signal to the electronic device. The electronic device may receive the information and may store the received information in a memory. The electronic device may transmit separate identification information (e.g., a headendID) to the first IoT server 1502 based on the received identification information such that the separate identification information is mapped onto the identification information (e.g., the first identification information) of the external electronic device 1506, the identification information (e.g., the second identification information) of the second electronic device 1503 associated with the external electronic device 1506, the content provider information, and control information of the external electronic device 1506 and the mapping result is stored in a database.

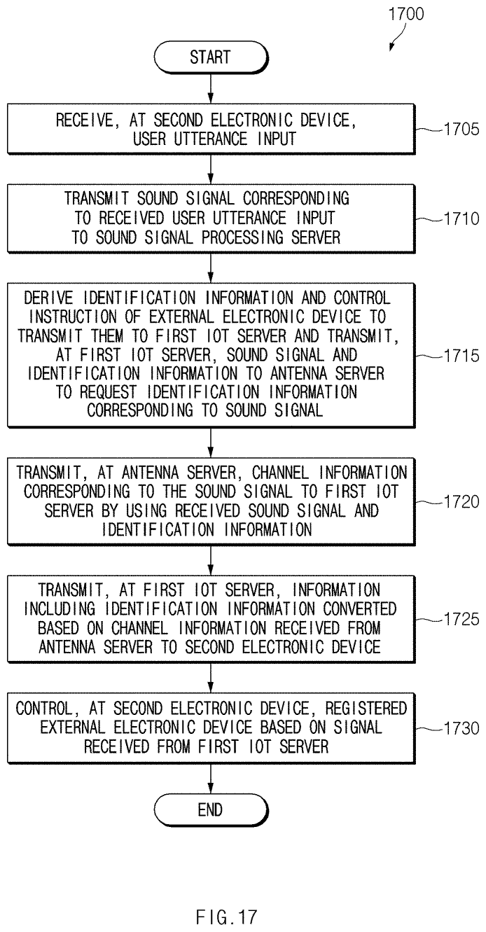

FIG. 17 illustrates an operation flowchart 1700 of an additional user interface when an external electronic device to be registered at an electronic device is a TV, according to various embodiments.

Referring to FIG. 17, according to an embodiment, in operation 1705, a second electronic device (e.g., the second electronic device 1130 of FIG. 11) (e.g., an AI speaker) may receive an utterance input of the user. For example, the second electronic device may obtain the received utterance input of the user as a sound signal. For example, the second electronic device may obtain a sound signal associated with a control command for controlling an external electronic device (e.g., the external electronic device 1140 of FIG. 11).

According to an embodiment, in operation 1710, the second electronic device may transmit the sound signal corresponding to the received utterance input of the user to a sound signal processing server (e.g., the sound signal processing server 1170 of FIG. 11). For example, the sound signal may further include information (e.g., channel information, content information, or genre information) about an operation of the external electronic device to be controlled.

According to an embodiment, in operation 1715, the sound signal processing server may derive identification information (e.g., the first identification information) of the external electronic device and/or a control instruction from the sound signal received from the second electronic device and may transmit the identification information and the control instruction to a first IoT server (e.g., the first IoT server 1120 of FIG. 11); the first IoT server may transmit identification information (e.g., headendID), which is received from an antenna server (e.g., the antenna server 1160 of FIG. 11) when registering the external electronic device, and the sound signal to the antenna server and may request identification information corresponding to the sound signal. For example, the sound signal may be a signal corresponding to the utterance input of the user, “Change into the NBC channel”. The identification information may include identification information of the “NCB” channel.

According to an embodiment, in operation 1720, the antenna server may transmit channel information corresponding to the sound signal to the first IoT server by using the sound signal and the identification information (e.g., headendID) received from the first IoT server. The channel information may include channel information based on the sound signal and the identification information (e.g., headendID) received from the antenna server.

According to an embodiment, in operation 1725, the first IoT server may convert the channel information received from the antenna server into a code-set name and code-key name information and may transmit information including the converted information to the second electronic device. For example, the information may include a control signal commanding the second electronic device to control the external electronic device.

According to an embodiment, in operation 1730, the second electronic device may control a registered external electronic device, based on the control signal received from the first IoT server. For example, the second electronic device may transmit the control signal to the external electronic device by using a specified wavelength (e.g., an infrared wavelength), depending on the signal received from the first IoT server. According to various embodiments, under control of the second electronic device, the external electronic device may perform the following operation associated with the control signal: changing a channel, broadcasting a program in which content genre information determined based on an utterance input of the user is included. In this case, the external electronic device may receive the control signal only through the specified wavelength (e.g., an infrared wavelength).

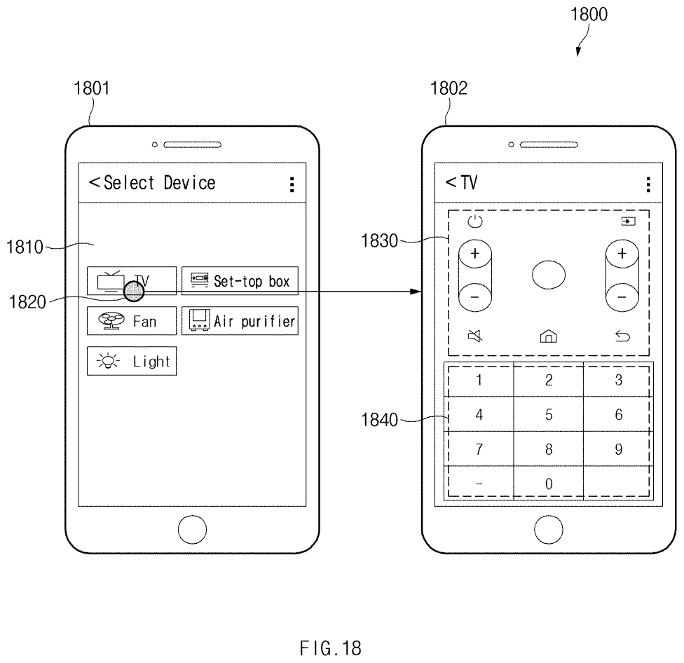

FIG. 18 illustrates a user interface 1800 providing a remote control function to control an external electronic device, according to various embodiments.

Referring to FIG. 18, according to an embodiment, in screen 1801, a list 1810 of external electronic devices (e.g., the external electronic device 1140 of FIG. 11) registered at a first electronic device (e.g., the first electronic device 1110 of FIG. 11) may be output in the user interface. Names and kinds of registered devices, and/or icons expressed by illustrations may be included in the external electronic device list 1810. When a user input 1820 on at least one of the icons of the registered devices in the external electronic device list 1810 is sensed, screen 1802 may be output.

The configuration of the user interface illustrated in screen 1801 is exemplary, and embodiments of the disclosure are not limited thereto. For example, as well as a name of an external electronic device, brand information, current operation state information, and the like of the corresponding device may be further included in the external electronic device list 1810. For another example, the user interface is illustrated as only names are enumerated in the external electronic device list 1810, but embodiments of the disclosure are not limited thereto. The external electronic device list 1810 may be output for each location (e.g., a bedroom, a living room, a room, or the like) where the external electronic device is disposed.

According to an embodiment, in screen 1802, a screen 1830 in which a plurality of buttons for controlling the external electronic device are included may be output at the top of the user interface. For example, the plurality of buttons may include buttons for power ON/OFF, a volume control, channel change, mute, backward, home screen output, and the like. A keypad screen 1840 may be output at the bottom of the user interface. For example, the keypad screen 1840 may include a plurality of buttons supporting a number input, a character input, a figure input, and the like. For example, when a user input on a part of the buttons of the user interface is sensed, the first electronic device may transmit a control signal (e.g., capability information or identification information (e.g., the first identification information) of an external electronic device) enabling an execution of a function (e.g., a power ON/OFF, a volume control, channel change, mute, backward, or home screen output function) corresponding to the button to a first IoT server (e.g., the first IoT server 1120 of FIG. 11). The first IoT server may convert the received control signal into information about a device type, a code-set name, a code-key, or the like, may verify identification information (e.g., the second identification information) of a second electronic device (e.g., the second electronic device 1130 of FIG. 11) based on the converted information and the identification information (e.g., the first identification information) of the external electronic device, and may transmit information about the converted device type, code-set name, or code-key to the second electronic device. The second electronic device may control the external electronic device through a specified wavelength (e.g., an infrared wavelength), based on the control signal received from the first IoT server.

The configuration of the user interface illustrated in screen 1802 exemplifies the case of selecting a TV of registered devices in screen 1801, and embodiments of the disclosure are not limited thereto. For example, in the case of selecting an electric fan, the user interface in screen 1802 may further include a button supporting a function such as air volume control, rotation operation, operation time reservation, or the like.

According to various embodiments, a method for controlling an external electronic device may include receiving, from a first electronic device, first identification information including information about the external electronic device determined based on selection of a user and second identification information including information about a second electronic device, determining the second electronic device based on the second identification information and transmitting the first identification information to the second electronic device thus determined, obtaining control information of the external electronic device corresponding to the first identification information through the second electronic device, transmitting the control information to the first electronic device, receiving content provider information associated with the external electronic device from the first electronic device, mapping the external electronic device onto the first identification information, the second identification information, the content provider information, and the control information of the external electronic device and storing a result of the mapping in a database, receiving a control common associated with the external electronic device from the first electronic device, and, when a control command for the external electronic device is obtained, transmitting control information to the second electronic device based on the database such that the second electronic device radiates a signal of a specified wavelength corresponding to an operation the control command.

According to an embodiment, the transmitting of the control information to the second electronic device may include identifying channel information corresponding to the control command by using the content provider information mapped onto the external electronic device.

According to an embodiment, the identifying of the channel information may include obtaining at least one of programming details and content genre information by using the content provider information mapped onto the external electronic device, and identifying the channel information based on at least one of the programming details and the content genre information.

According to an embodiment, the obtaining of the control information of the external electronic device corresponding to the first identification information through the second electronic device may include transmitting the first identification information to the second electronic device, and receiving the control information of the external electronic device obtained by the second electronic device from the second electronic device, and the control information may include information of an operation supported by the external electronic device and at least one information corresponding to a signal of a specified wavelength corresponding to the operation supported by the external electronic device.

According to an embodiment, the method for controlling the external electronic device may further include receiving a control command for the external electronic device from a sound signal processing server, and the sound signal processing server may generate the control command by processing a user utterance input obtained by the first electronic device or the second electronic device.

Meanwhile, the method for controlling the external electronic device according to various embodiments of the disclosure may be stored in a non-transitory readable medium. The non-transitory readable medium may be mounted and used in various devices.

Herein, the non-transitory readable medium refers to not a medium, which stores data for a short time, such as a register, a cache, a memory, or the like but a medium that stores data semi-permanently and is read by a device. In detail, the above programs may be stored and provided in the non-transitory readable medium such as a CD, a DVD, a hard disk, a blue-ray disk, a USB, a memory card, a ROM, or the like.

According to various embodiments of the disclosure, an electronic device obtaining an utterance input of a user may use any other electronic device in which the emission of a specified wavelength (e.g., an infrared light) is possible, thus making it possible to transmit a control signal corresponding to the utterance input to an IoT device controlled by the specified wavelength.

Besides, a variety of effects directly or indirectly understood through this disclosure may be provided.

Although the present disclosure has been described with various embodiments, various changes and modifications may be suggested to one skilled in the art. It is intended that the present disclosure encompass such changes and modifications as fall within the scope of the appended claims.

What is claimed is:

1. A server that supports an operation of an IoT environment, comprising:
a communication circuit; and
a processor electrically connected with the communication circuit, wherein the processor is configured to:
receive a sound signal corresponding to an utterance input of a user from a first electronic device through the communication circuit;
derive identification information and a control command of an IoT device from the sound signal;
determine whether it is possible to control the IoT device by using the first electronic device; and
transmit, to a second electronic device associated with the IoT device, a control signal corresponding to the control command based on a result of the determination indicating the second electronic device is to use a specified wavelength to control the IoT device.

2. The server of claim 1, further comprising:
a memory,
wherein the processor is further configured to store IoT device information and second electronic device information in the memory in association with a specified place.

3. The server of claim 1, wherein the processor is further configured to:
when the second electronic device associated with the IoT device includes a plurality of second electronic devices, select one of the plurality of second electronic devices based on at least one of location information about the IoT device and network performance information about the IoT device.

4. The server of claim 1, wherein the processor is further configured to:
transmit a request signal for a control of the IoT device to the second electronic device associated with the IoT device.

5. The server of claim 4, wherein the processor is further configured to:
transmit the control signal to the second electronic device depending on a response of the second electronic device to the request signal.

6. The server of claim 5, wherein the processor is further configured to:
receive a response associated with another sound signal from the second electronic device.

7. The server of claim 1, wherein the processor is further configured to:
when the identification information of the IoT device is plural, allow the second electronic device to transmit the control signal to an IoT device selected from the first electronic device based on the plural of the identification information of the IoT device.

8. The server of claim 1, wherein the processor is further configured to:
allow the second electronic device to transmit the control signal to the IoT device using the specified wavelength corresponding to an infrared wavelength.

9. An electronic device that supports an operation of an IoT environment, comprising:
a communication circuit; and
a processor electrically connected with the communication circuit, wherein the processor is configured to:
transmit a sound signal corresponding to an utterance input of a user to a server through the communication circuit; and
when identification information and a control command of an IoT device is derived from the sound signal by the server, allow the server to transmit a control signal corresponding to the control command to another electronic device associated with the IoT device, based on whether the IoT device corresponding to the derived identification information is controllable by the electronic device.

10. The electronic device of claim 9, wherein the processor is further configured to:
control the server to indicate that the other device controls the IoT device using a specified wavelength.

11. The electronic device of claim 9, wherein the processor is configured to:
when the electronic device fails to transmit a specified wavelength, allow the server to transmit the control signal to the other electronic device.

12. The electronic device of claim 9, further comprising:
a speaker,
wherein the processor is further configured to output whether to transmit the control signal by using the speaker.

13. The electronic device of claim 9, wherein the sound signal corresponds to at least one of at least one syllable, a word in which the at least one syllable is included, or a sentence in which the word is included.

14. A method for controlling an IoT device comprising:
receiving a sound signal corresponding to an utterance input of a user from a first electronic device;
deriving identification information and a control command of the IoT device from the sound signal;
determining whether it is possible to control the IoT device with the first electronic device; and
transmitting, to a second electronic device associated with the IoT device, a control signal corresponding to the control command based on a result of the determination indicating the second electronic device is to use a specified wavelength to control the IoT device.

15. The method of claim 14, further comprising:
storing IoT device information and second electronic device information in a memory in association with a specified place.

16. A non-transitory computer-readable storage medium including a program, for controlling an external electronic device, the program when executed by a processor on an electronic device causes the processor to:
receive, from a first electronic device, first identification information including information about the external electronic device determined based on selection of a user and second identification information including information about a second electronic device;
determine the second electronic device based on the second identification information and transmitting the first identification information to the second electronic device thus determined;
obtain control information of the external electronic device corresponding to the first identification information through the second electronic device;
transmit the control information to the first electronic device;
receive content provider information associated with the external electronic device from the first electronic device;
map the external electronic device onto the first identification information, the second identification information, the content provider information, and the control information of the external electronic device and storing a result of the mapping in a database;
receive a control command associated with the external electronic device from the first electronic device; and
when the control command for the external electronic device is received, transmit control information to the second electronic device based on the database, wherein the control information indicates that the second electronic device is to radiate a signal of a specified wavelength corresponding to an operation corresponding to the control command.

17. The non-transitory computer-readable storage medium of claim 16, wherein the program that when executed causes the processor to transmit the control information to the second electronic device additionally causes the processor to:
identify channel information corresponding to the control command by using the content provider information mapped onto the external electronic device.

18. The non-transitory computer-readable storage medium of claim 17, wherein the program that when executed causes the processor to identify the channel information additionally causes the processor to:
obtain at least one of programming details and content genre information by using the content provider information mapped onto the external electronic device; and
identify the channel information based on at least one of the programming details and the content genre information.

19. The non-transitory computer-readable storage medium of claim 16, wherein the program that when executed causes the processor to obtain the control information of the external electronic device corresponding to the first identification information through the second electronic device additionally causes the processor to:
transmit the first identification information to the second electronic device; and
receive the control information of the external electronic device obtained by the second electronic device from the second electronic device, and
wherein the control information includes information of an operation supported by the external electronic device and at least one information corresponding to a signal of a specified wavelength corresponding to the operation supported by the external electronic device.

20. The non-transitory computer-readable storage medium of claim 16, wherein the program that when executed further causes the processor to:
receive a control command for the external electronic device from a sound signal processing server, and
wherein the sound signal processing server generates the control command by processing a user utterance input obtained by the first electronic device or the second electronic device.
